(19) United States
(12) Patent Application Publication
(10) Pub. No.: US 2026/0073122 A1
(43) Pub. Date: Mar. 12, 2026

(54) SYSTEMS AND METHODS FOR EDITING NEURAL NETWORK-GENERATED TEXT

(71) Applicant: Salesforce, Inc., San Francisco, CA (US)

(72) Inventors: Tuhin Chakrabarty, New York, NY (US); Philippe Laban, New York, NY (US); Chien-Sheng Wu, Mountain View, CA (US)

(21) Appl. No.: 19/041,725

(22) Filed: Jan. 30, 2025

Related U.S. Application Data
(60) Provisional application No. 63/694,007, filed on Sep. 12, 2024.

(51) Int. Cl. G06F 40/166; G06F 16/3329

(52) U.S. Cl. CPC G06F 40/166; G06F 16/33295

(57) ABSTRACT

Embodiments described herein provide a method of detecting whether an input text is AI-generated using a neural network based language model. The method may include: formulating a span detection prompt including the input text and examples of problematic texts; generating, using the neural network based large language model in response to the span detection prompt, a textual spans in the input text and a category for each textual span in the plurality of textual spans; formulating an edit category prompt including the plurality of textual spans, the category for each textual span, and a plurality of example edits for each category; generating, using the neural network based large language model in response to the edit category prompt, a plurality of edited textual spans associated with the category; generating a revised sample text from the edits of the plurality of textual spans; and outputting, to a display, the revised sample text.

### CROSS REFERENCE(S)

The instant application is a nonprovisional of and claim priority under 35 U.S.C. 119 to U.S. provisional application No. 63/694,007, filed Sep. 12, 2024, which is hereby expressly incorporated by reference herein in its entirety.

### TECHNICAL FIELD

The embodiments relate generally to machine learning systems for natural language processing, and more specifically to editing neural network-generated text.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model (e.g., large language models) to generate an output such as in the form of a text response, or a series of actions to complete a complex task, such as to network issue troubleshooting, etc.

Such generative language model receives a natural language input in the form of a sequence of tokens, and in turn generates a predicted distribution over a token space conditioned on the input sequence. Generated output tokens over time may in turn form the text response, or actions for completing the task. These neural network based generative language models are often large language models (“LLMs”) that are pre-trained but then refined using reinforcement learning from human feedback. For example, to prevent the misuse of such technology for harmful purposes, such as spreading misinformation, generating malicious content, or manipulating individuals, safeguards include implementing robust content filters, ethical guidelines, and monitoring systems to detect and block abusive outputs. Additionally, developers can incorporate alignment techniques, like reinforcement learning from human feedback (RLHF) or direct preference optimization (DPO), to ensure AI systems prioritize truthful, ethical, and beneficial responses.

### BRIEF DESCRIPTION OF THE DRAWINGS

FIG. 1 is a simplified diagram illustrating a comparison of two types of model alignment, according to some embodiments.

FIG. 2A is a simplified diagram illustrating instruction-response pair generation, according to some embodiments.

FIG. 2B is a table displaying example edits for different edit categories, according to some embodiments.

FIG. 3A is a simplified diagram illustrating a framework for editing LLM-generated text, according to some embodiments.

FIG. 3B shows an application of an LLM based AI agent, according to embodiments of the present disclosure.

FIG. 4A is a simplified diagram illustrating a computing device implementing instruction-response pair generation and the frameworks for editing LLM-generated text described in FIGS. 1-3, according to some embodiments.

FIG. 4B is a simplified diagram illustrating a neural network structure, according to some embodiments.

FIG. 5 is a simplified block diagram of a networked system suitable for implementing instruction-response pair generation and the framework for editing LLM-generated text described in FIGS. 1-3 and other embodiments described herein.

FIG. 6 is an example logic flow diagram illustrating a method of editing LLM-generated text based on the framework shown in FIGS. 1-3, according to some embodiments.

FIGS. 7-16 provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

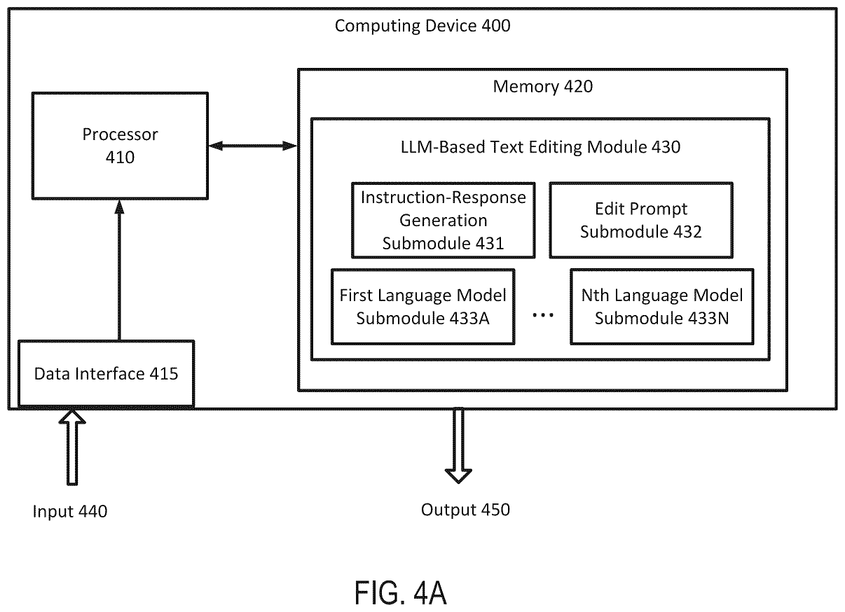

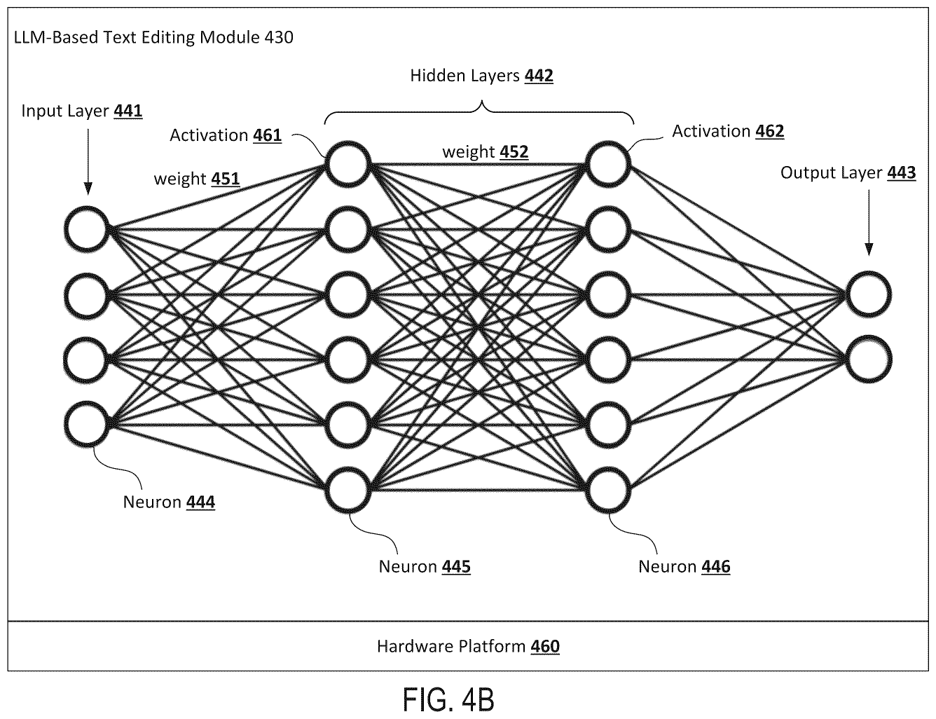

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 4B

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

### Overview

Large language models (LLMs) are widely used in AI-assisted writing tools to complete writing tasks across a wide variety of domains from science to creative writing. LLMs may be refined to align their output texts to match human-generated texts in style and quality. These large language models are often pre-trained but then refined using reinforcement learning from human feedback, referred to as traditional alignment. The human feedback is often a choice between two text outputs by an LLM, known as reinforcement learning from human feedback (RLHF).

However, when RLHF is often limited to choosing between texts both generated by a LLM, even the preferred LLM-generated text that better aligns with human preference would still have similar flaws. Quality of LLM output is largely limited.

In view of the need for improved systems and methods for LLM-generated text, embodiments described herein provide a human-feedback based framework for editing LLM-generated text. For example, a human-edited text dataset may include an LLM-generated text and edits made by humans. Using the human-edited texts, an input prompt may be generated to include the query, the LLM-generated text and the edits as an input for the LLM. The LLM may then, according to the prompt, detect problematic spans from the query and determine a categorization for the type of problem in the span. Then the LLM may generate suggested edits for the problematic spans using prompts that include examples of edits for each category. A revised text may be generated using the edits of the problematic spans.

For example, an LLM moderator may be incorporated as a safety “firewall” into the architecture of an AI agent to edit model-generated responses, to enhance AI safety and prevent the dissemination of misinformation. Such AI agent may comprise a primary LLM as a generator to generate a response to user queries, and a secondary LLM trained as a real-time LLM moderator to analyze and refine the primary LLM's outputs to ensure they align with ethical guidelines, factual accuracy, and user safety. For instance, if the primary LLM generates a response containing harmful content, biased language, or factual inaccuracies, the LLM moderator can detect these issues and either rewrite, filter, or flag the response before it reaches the user. By integrating such a safety firewall implemented by an LLM moderator, AI misuse can be reduced so as to improve AI system reliability.

In some embodiments, the LLM moderator may be implemented as a detector to detect AI-generated texts. For example, in some applications such as online education, etc., use of AI-generated text is limited. The LLM moderator may be used to detect AI-generated texts, using embodiments described herein, to reduce the AI misuse.

Embodiments described herein provide a number of benefits. Using this framework for generating text, idiosyncrasies and non-human characteristics of text may be reduced, improving alignment with human-generated texts. With improved performance on alignment with human-generated texts, neural network technology in AI-based writing assistants is improved.

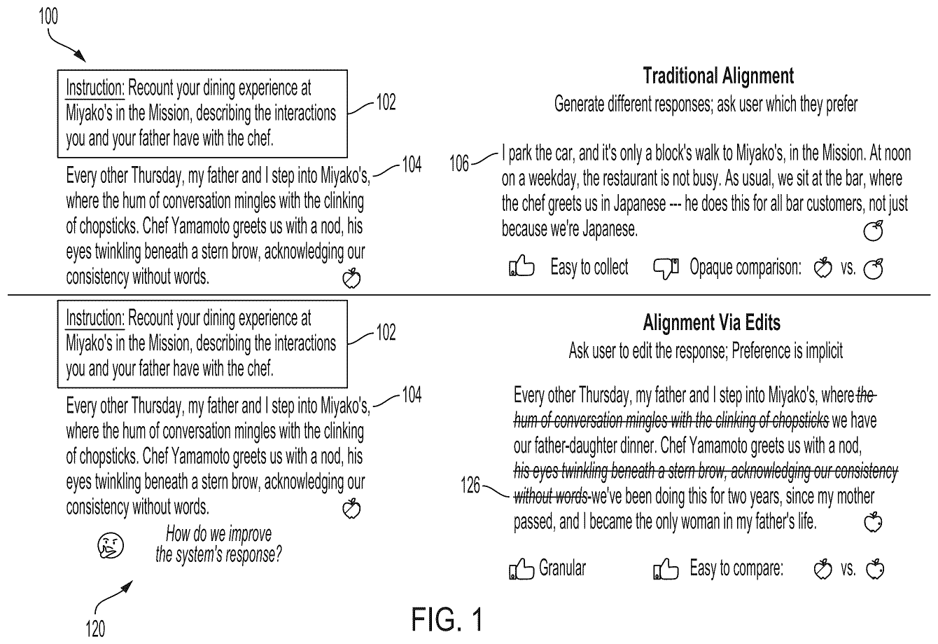

FIG. 1 is a simplified diagram illustrating a comparison of two types of model alignment, traditional alignment 100 and alignment via edits 120, according to some embodiments. Both models of alignment utilize outputs from pre-trained LLMs for evaluation. A pre-trained LLM may generate a first response 104 from instruction 102. The first response 104 may include natural language text that is responsive to the instruction, e.g., a question or prompt, provided to the pre-trained LLM.

In traditional alignment, pre-trained language models that are refined through Reinforcement learning from human feedback (RLHF). RLHF transforms human preferences into training data to guide language models toward desired outcomes. The most common type of feedback used with RLHF is binary preferences between pairs of examples sampled from one or more language models. For example, a human may be asked their preference between first response 104 and second response 106. This approach has a drawback. The first response 104 and second response 106 may differ in numerous ways and could be equally flawed in containing idiosyncrasies. Asking an annotator to choose between two undesirable outputs does not improve alignment.

In alignment via edits 120, a first response 104 to instructions 102 is edited by a human user to generate an edited response 126. By editing the first response, a user's preference is indicated by the edits they made to the first response. Thus, when the edited response 126 is used to refine the pre-trained LLM and/or its output, alignment is enhanced. In some embodiments, alignment via edits 120 may include several steps. For example, identifying a comprehensive taxonomy of edit categories based on expert writing practices. Collecting edits LLM-generated text by human writers using categories from the taxonomy. Edits may be defined as changes in the LLM-generated texts that alter, replace, or refine specific phrases, clauses, or sentences within a larger text. Text may be generated in any genre, e.g., literary fiction, creative non-fiction, non-fiction news article, journal articles, etc. In some embodiments, text may be generated in literary fiction and creative non-fiction, as these genres challenge LLMs with their creativity, emotional nuance, and sophisticated language use.

In some embodiments, paragraph-level edits may be used as they balance granularity and scope, reducing costs and annotator fatigue. Paragraphs may capture style and context better than sentences, enabling more cohesive improvements. Given LLMs' limitations in long-term discourse coherence, paragraph-level enhancements facilitate human-AI collaboration. Finally, few-shot prompts may include human writer's edits to identify problematic spans in LLM-generated paragraphs and suggest improvements. Thus, overall paragraph quality may be improved at scale.

In some embodiments, one or more design principles may be used to improve AI generated text through edits. For example, design principles may include (1) developing a comprehensive edit taxonomy grounded in expert writing practices, (2) leveraging edits to balance meaning preservation and substantive semantic changes, and (3) utilizing edits as a mechanism for enhancing human-AI alignment in writing.

The first principle emphasizes creating a comprehensive taxonomy of edit categories based on expert editor and writer's practices. Experts and novices define revising in very different ways with experts attending more systematically to different aspects of the text than novices. By developing such a taxonomy, analyzing and enhancing LLM-generated text may be done systematically. It also allows for a fine-grained understanding of the specific areas where AI writing may fall short and enables targeted improvements. Basing the taxonomy in expert writing practices ensures that the edits align with the standards of high-quality writing and is acceptable to its readers. The first principle also acknowledges the complexity of the editing process, recognizing that different categories of edits may be required at various levels of the text, from sentence-level corrections to broader structural changes.

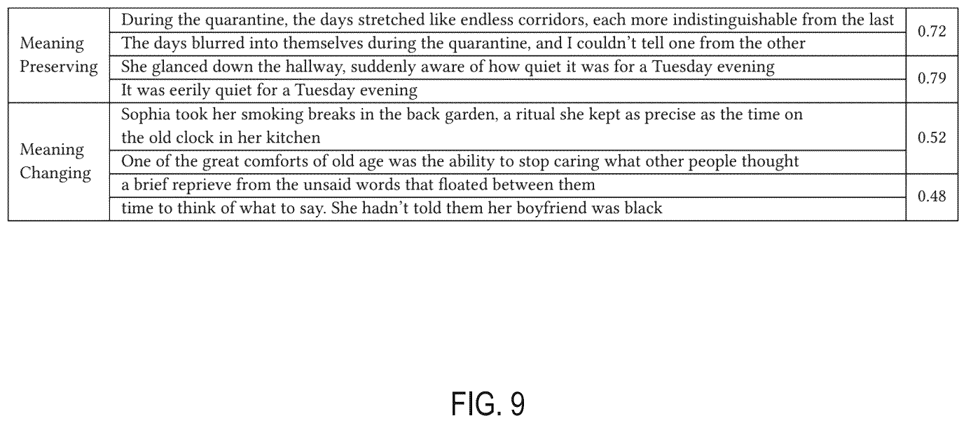

The second principle recognizes that preserving core meaning and intent of the original text is crucial to maintain coherence and faithfulness to the initial ideas once editing has occurred. However, introducing substantive semantic changes is often required to adhere to the quality and characteristics of good writing. LLM-generated text often benefits from syntactic edits. Syntactic edits (primarily meaning-preserving) enhance readability by diversifying sentence structures, expanding vocabulary choices, and minimizing repetitive phrasing. Consequently, semantic edits (both meaning preserving and changing) in AI writing are important for enhancing specificity or reducing unnecessary flourishes and clichés that can otherwise obscure meaning. The methods and systems described herein accommodate the tension between maintaining original meaning and introducing necessary improvements to mitigate AI-specific writing idiosyncrasies. See FIG. 9 for examples of meaning preserving and meaning changing edits and associated semantic similarity scores (BERT scores) between the original and edited texts.

The third principle recognizes that edits enhance alignment of LLM-generated text with human-generated text. Current AI writing systems are developed using pre-trained language models (LMs) refined through human interaction, employing supervised learning and reinforcement learning (RL) techniques. Reinforcement learning from human feedback (RLHF) is a key approach, transforming human input into training data to guide LMs toward desired outcomes. The most common type of feedback used with RLHF is binary preferences between pairs of examples sampled from one or more LLMs. However, a learned preference ordering can fail to converge to the true one when the desirability of examples depends on noise. In some embodiments, edits are a mechanism for enhancing alignment. An LLM-generated response that has been edited typically contains fewer undesirable traits and can be paired with the original LLM-generated response for preference ranking, i.e., edited preferred over original.

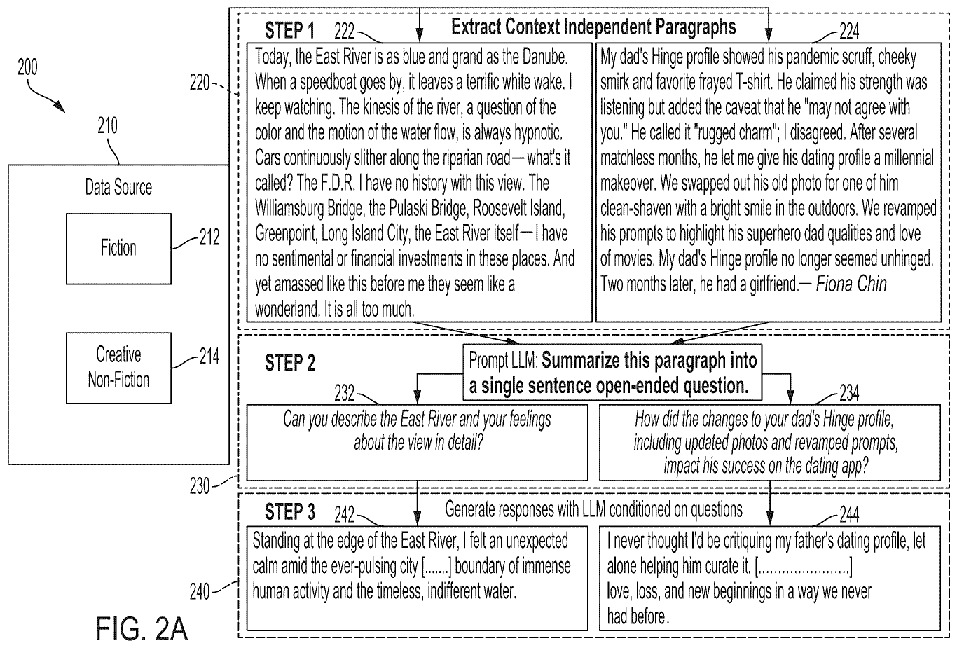

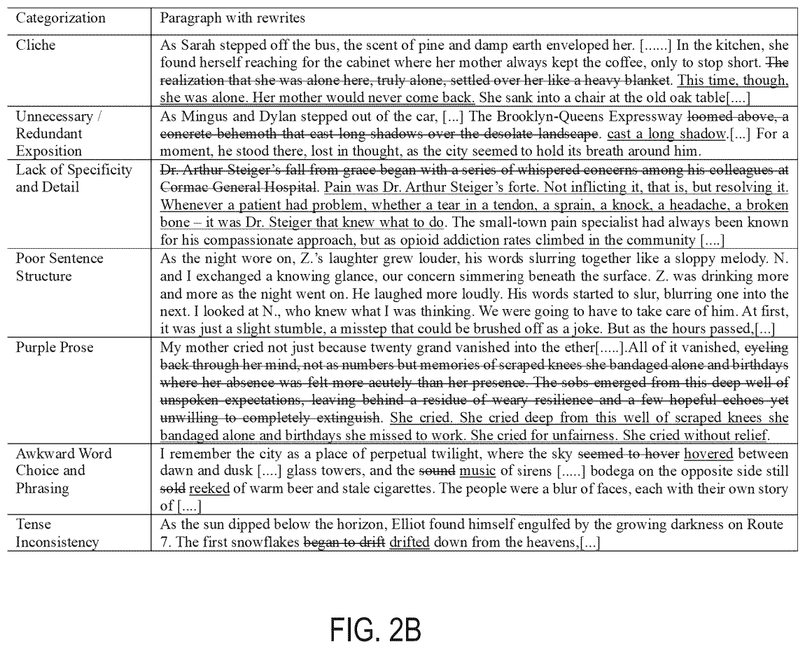

FIG. 2A is a simplified diagram illustrating an instruction-response pair generation pipeline 200, according to some embodiments. The instruction-response pair generation pipeline 200 produces an initial set of LLM-generated responses that users may edit. The edited LLM-generated response may be used to guide editing of new LLM-generated response through few-shot prompts, as described in FIG. 2B. The instruction-response pair generation pipeline 200 includes a data source 210, a first step 220, a second step 230, and a third step 240.

Data source 210 may include writing samples of varying lengths and genres chosen from various sources. In some embodiments, as shown in FIG. 2A, data source 210 may include text samples in fiction 212 and text samples in non-fiction 214. Text samples in data source 210 may be of varying lengths from 1-2 paragraph up through tens and hundreds of pages.

At a first step 220, paragraphs from text samples in data source 210 may be extracted. In some embodiments, between 100-700 pieces of writing may be chosen from different writing collections in data source 210, and individual paragraphs may be selected from each piece of writing. The individual paragraphs may be manually reviewed to ensure they are long enough and can stand alone as coherent pieces of writing without requiring additional context. In total, approximately 1200 paragraphs may be selected following this procedure. The Literary Fiction genre has a larger representation (e.g., 80%) in one selection, while the creative non-fiction genres have a smaller representation. First step 220 depicts an exemplary fiction paragraph 222 and non-fiction paragraph 224 extracted from different pieces of writing.

At a second step 230, individual paragraphs are summarized into a single sentence open-ended question. In some embodiments, instructions may be automatically generated, where instructions correspond to each of the selected paragraphs. Specifically, an LLM (i.e., GPT40) may be prompted to summarize each paragraph into an open-ended question. Questions obtained through back-translation (see examples in Table 1 below) can be interpreted as realistic writing instructions. In some embodiments, the generated instructions may be manually verified, filtering out questions that were ill-formed or overly specific, yielding a total of 1,057 writing instructions.

TABLE 1

| | Source & | | |
|---|---|---|---|
| Domain | Genre | Example Seed Paragraph with Generated Instruction | #N |
| Fiction | The | The sunset is a red-gold rumpus on the western sky. It has rained. The | 815 |
| | NewYorker | crow tosses itself from branch to branch, pole to pole, glistening on its | |
| | (Literary | pace, and she follows. They are soon far from where they began, streets | |
| | Fiction) | unfamiliar to her, an older part of town, [. . .]. A man reading. Old | |
| | | Christmas tree in a corner. It feels secret. The sky is clearing overhead. | |
| | | She feels secret, too. She feels tremendous. | |
| | | Instruction: Can you describe a vivid scene at sunset that transitions | |
| | | into nighttime, incorporating elements of nature, urban surroundings, | |
| | | and personal observations? | |
| Creative | NYTimes | Prague, the Czech capital, is finding a new balance between preserving | 110 |
| Non- | (Travel | its past and embracing the future, improving many of its important | |
| Fiction | Writing) | historic sites while making striking additions to its skyline. [. . .] Stop | |
| | | by for a coffee, hit up one of the many great new bakeries or visit a | |
| | | charismatic old beer hall as you explore a city that is clearly entering | |
| | | its prime. | |
| | | Instruction: How is Prague balancing its historical preservation with | |
| | | modern development while enhancing local amenities and vibrant | |
| | | neighborhoods outside Old Town? | |
| | NYTimes | The origins of the fruit sandwich are believed to go back to Japan's | 83 |
| | (Food | luxury fruit stores & the fruit parlors attached to them. This version | |
| | Writing) | comes from Yudai Kanayama, a native of Hokkaido who runs the | |
| | | restaurants the Izakaya NYC and Dr Clark in New York. [. . .]. The | |
| | | sandwich looks like dessert but isn't, or not exactly; it makes for a | |
| | | lovely little meal that feels slightly illicit, as if for a moment there are | |
| | | no rules. | |
| | | Instruction: How did Yudai Kanayama reinvent the traditional | |
| | | Japanese fruit sandwich to create a unique culinary experience? | |
| | NYTimes | My dad's Hinge profile showed his pandemic scruff, cheeky smirk and | 19 |
| | (Personal | favorite frayed T-shirt. He claimed his strength was listening [. . .] We | |
| | Essay) | revamped his prompts to highlight his superhero dad qualities and love | |
| | | of movies. My dad's Hinge profile no longer seemed unhinged. Two | |
| | | months later, he had a girlfriend. | |
| | | Instruction: How did the changes to your dad's Hinge profile, | |
| | | including updated photos and revamped prompts, impact his success | |
| | | on the dating app? | |
| | Dear Sugar | What is a prestigious college? What did attending such a school allow | 30 |
| | (Internet | you to believe about yourself? What assumptions do you have about | |
| | Advice) | the colleges that you would not describe as prestigious? What sorts of | |
| | | people go to prestigious colleges and not [. . .]I believe our early | |
| | | experiences and beliefs about our place in the world inform who we | |
| | | think we are and what we deserve and by what means it should be | |
| | | given to us. | |
| | | Instruction: How do your beliefs and assumptions about educational | |
| | | privilege and the type of schools people attend shape your current view | |
| | | of yourself and others? | |

At a third step 240, responses are generated using LLMs conditioned on the questions generated in the second step 230. In some embodiments, the generated instructions may be input into three state-of-the-art LLMs, GPT-40, Claude-3.5-Sonnet, and Llama 3.1-70b, to generate responses. Each LLM may be used to generate responses to one-third of the generated instructions. Each LLM may respond to instructions across all domains in equal proportion. To generate high-quality responses, each LLM is provided input with the writing instruction, as well as the genre and source, and an instruction to adhere to the style of the venue. The prompt further specifies: “Try your best to be original, avoiding clichés or overused tropes. Do not use ornamental language and focus on nuance, simplicity, and subtext”. Through this process 1,057 writing <instructions, response> pairs may be generated, with responses averaging 205 words. Table 2 shows examples of the prompts for generating instructions and responses.

TABLE 2

| | |
|---|---|
| Instruction | Summarize this paragraph into a single sentence open-ended question. \n |
| Prompt | {{paragraph}} |
| | Summarize this paragraph into a single sentence open-ended instruction. \n |
| | {{paragraph}} |
| Response | Imagine you are a fiction writer for the NewYorker. Now write a paragraph |
| Prompt | (10-15 sentence) as a response to the following question. Try your best to be |
| | original, avoiding cliches or overused tropes. Do not use ornamental language |
| | and focus on nuance, simplicity, and subtext. Start directly with your |
| | response. \n {{instruction}} |
| | Imagine you are a writer for the New York Times Modern Love section. |
| | Now write a paragraph (10-15 sentence) as a response to the following |
| | question. Try your best to be original, avoiding cliches or overused |
| | tropes. Do not use ornamental language and focus on nuance, simplicity, |
| | and subtext. Start directly with your response \n {{instruction}} |
| | Imagine you are a writer for the New York Times Cooking section. Now write |
| | a paragraph (10-15 sentence) as a response to the following question. Try |
| | your best to be original, avoiding cliches or overused tropes. Do not use |
| | ornamental language and focus on nuance, simplicity, and subtext. Start |
| | directly with your response \n {{instruction}} |
| | Imagine you are a writer for the New York Times Travel section. Now write a |
| | paragraph (10-15 sentence) as a response to the following question. Try your |
| | best to be original, avoiding cliches or overused tropes. Do not use |
| | ornamental language and focus on nuance, simplicity, and subtext. Start |
| | directly with your response \n {{instruction}} |
| | Imagine you are a beloved female Internet advice columnist whose |
| | trademark is deeply felt and frank responses grounded in your own personal |
| | experience. Now write a paragraph (10-15 sentence) as a response to the |
| | following question. Try your best to be original, avoiding cliches or overused |
| | tropes. Do not use ornamental language and focus on nuance, simplicity, and |
| | subtext. Start directly with your response \n {{instruction}} |

After the dataset of instruction-response pairs has been created, human users may edit the responses. Human users may be selected for copy-editing experience and/or other domain expertise. For example, users may be required to have a Master of Fine Arts in Creative Writing. For example, users may be shown a paragraph from a pair and the user may highlight problematic response spans, suggested rewrites, and tag each span with a free-form category to characterize the issue. In one embodiment, eight human participants were recruited, with each completing annotations for 25 samples. In total, the eight participants edited 200 paragraphs, annotating roughly 1,600 edits attributed to 50 distinct initial categories.

In some embodiments, the 50 distinct categories may be reduced to a final 7 distinct categories. In some embodiments, a general inductive approach for qualitative data analysis may be used to synthesize these 50 initial categories into a comprehensive, fine-grained taxonomy of edits. First, two human users may independently bucket the categories into initial low-level groups. Through iterative discussions, the groups may be refined to reduce overlap and establish shared groupings. The refined low-level groups were then aggregated into high-level categories. Each high-level category was assigned a name reflecting its generalized representation. Final categories may be retained only if derived from initial categories identified by at least four participants, ensuring majority representation in editing feedback. The seven categories may be defined as follows:

Cliché: Clichés in writing are pejoratively characterized as phrases, ideas, or sentences overused to the point of losing their original impact or meaning. They often use vivid analogies or exaggerations from everyday life to describe abstract concepts. While occasionally effective when used sparingly, the frequent use of clichés in writing is generally viewed as a sign of inexperience or lack of originality. Replacing clichés with fresh, original language improves the writing and engages readers more effectively.

Unnecessary/Redundant Exposition: Unnecessary or redundant exposition refers to the inclusion of excessive, repetitive, or implied information in writing. This common pitfall often involves restating the obvious or providing details that add little value. In a conversation with a human editor, they said “I'm adding a category of edit called “fluff”—this is a common term in the writing world to refer to unnecessary filler”. Effective writing embraces the principle of “show, don't tell,” allowing readers to infer meaning from context rather than relying on explicit explanations. Impactful writing often allows the core message to shine through without being obscured by unnecessary verbiage.

Purple Prose: In literary criticism, purple prose refers to excessively elaborate writing that disrupts the narrative flow by attracting undue attention to its flamboyant style. This can detract from the text's overall appreciation. Such writing is often difficult to read, using sprawling sentences, abstract words, and excessive adjectives, adverbs, and metaphors to convey little information. Careful editing can trim purple prose by replacing ornate language with more direct expressions, resulting in clearer writing that preserves narrative flow and the author's voice.

Poor Sentence Structure: Poor sentence structure reduces the clarity and readability of writing. A lack of proper transitions can make the text feel disjointed and hard to follow. Editing for clarity often reveals that it's better to split a convoluted thought into two sentences, rather than forcing it into one. Run-on sentences, characterized by multiple independent clauses improperly connected, are also frequent problems in AI writing. These, very long and complex sentences can overwhelm the reader, making the core message difficult to grasp. Edits that reduce these problems lead to more coherent and fluent text.

Lack of Specificity and Detail: Lack of specificity and details in writing often stems from a writer's tendency to rely on broad generalizations. This overly general approach fails to engage readers, leaving them unable to visualize scenes or connect with any given writing on a deeper level. Good writing often focuses on adding vivid details that create a clear mental image, contextualizing information to give it relevance, and deepening the internality of characters or subjects. Additionally, developing a unique voice through carefully chosen words and phrases can inject personality into the writing, making it more engaging and distinctive. Edits belonging to this category typically make the text longer as writers add more details to make the text engaging.

Awkward Word Choice and Phrasing: Awkward phrasing can significantly reduce writing quality, often confusing or disengaging readers. This issue typically involves misused or disproportionate use of certain words, unclear pronoun references, or an overuse of passive voice. A human editor said “Another little observation to share: a very common phrasing in these excerpts is ‘seem to_(verb)_’. This is not technically wrong it's just inelegant, something many writing teachers have told me to avoid. Unless there is some specific uncertainty or doubt about the verb action, it's always preferred to just use the verb without ‘seem’ (ex. from the current excerpt I have up: ‘amplified’ is better than ‘seemed to amplify’)”. Editing plays a crucial role in refining these elements. Through careful revision, writers can identify and replace imprecise or ill-fitting words with more appropriate alternatives, ensuring each term accurately conveys the intended meaning.

Tense Inconsistency: Tense inconsistency is a prevalent issue in writing. It occurs when a writer inadvertently shifts between past, present, and future tenses often even within the same paragraph or sentence. This grammatical misstep can make the timeline of events unclear and detract from the overall coherence of the text. Careful editing plays a crucial role in addressing this issue. By paying close attention to verb forms and temporal indicators, editors can improve writing that deals with tense inconsistency.

After a set of edit categories have been determined, a dataset of edited LLM-generated responses may be generated. In some embodiments, the dataset may include an edit category for each individual edit in an LLM-generated response.

In some embodiments, human participants may select any span of text in the response and suggest a rewrite. Human participants choose from the seven predefined categories in the taxonomy for each edit, rather than entering free-text categories. Participants had no set limit on edits per response but were urged to improve the text as they saw fit. All edits by the human participants were logged chronologically and offered an undo feature, enabling tracking of the entire editing process, not just the final product.

In some embodiments, after completing their edits, participants assigned two scores to the sample: an Initial Writing Quality Score (IWQS) for the original response quality, and a Final Writing Quality Score (FWQS) for the post-edit quality. Both used a 1-10 scale, with 1 being lowest and 10 being the highest quality. The scores may be incorporated to add a quantitative dimension to the qualitative process of editing. In some embodiments, scored are included in the final dataset which includes a response, edits of the response, and the final writing quality score.

In some embodiments, 18 writers with formal creative writing backgrounds from MFA mailing lists were recruited. These writers edited LLM-generated responses. In total, each of the 1,057<instruction, response> pairs was edited by at least one participant, and 50 responses were edited by three participants, allowing a of the study similarities and differences that occur when multiple writers edit the same response. In some embodiments, the dataset resulting from the edits by the writers, includes 8 edits per paragraph of the 1,057 LLM-generated paragraphs. The data includes paragraphs from Claude3.5 Sonnet (368), GPT40 (393), and Llama3.1-70B (296).

FIG. 2B is a table displaying example edits for different edit categories, according to some embodiments. In some embodiments, categories may include cliché, unnecessary/redundant exposition, lack of specificity and detail, poor sentence structure, purple prose, awkward word choice and phrasing, and tense inconsistency. For each of the categories shown in FIG. 2B, an example edit associated with the category is shown. Strikethrough is used to indicate text that is removed from the original response and underlining is used to indicate text that is added to the original response during editing. For example, in the cliché example, “The realization that she was alone here, truly alone, settled over her like a heavy blanket” is removed, i.e., the cliché is deleted, and “This time, though, she was lone. Her mother could never come back” is added to replace the cliché.

In some embodiments, different categories of edits may be present depending on the LLM used (e.g., what kind of text samples it was trained on) or the genre or type of text samples used to generate the instruction-response pair dataset as discussed above. For example, if technical writing samples were used to either train an LLM or used to generate instruction-response pairs, then a different set of edit categories reflecting different idiosyncrasies of LLMs may be used.

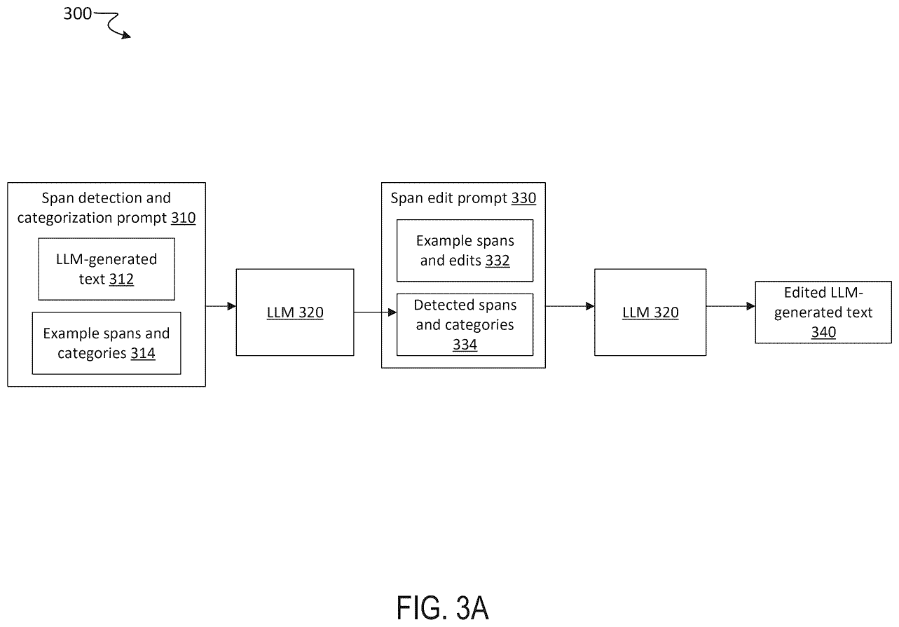

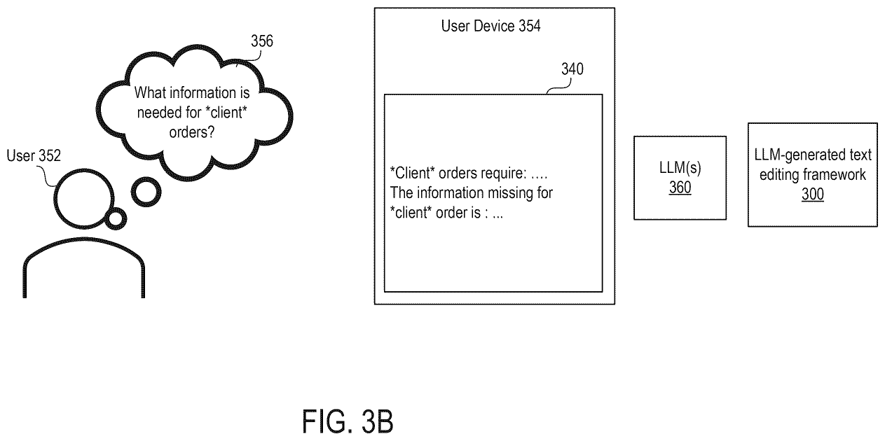

FIG. 3 is a simplified diagram illustrating a framework 300 for editing LLM-generated text, according to some embodiments. Framework 300 may be used to edit LLM-generated texts. For example, a user employing an AI-based writing assistant may query the writing assistant to generate a text sample responsive to the query. As part of the processing pipeline for the AI-based writing assistant, framework 300 may be employed to further refine the initial LLM-generated text 312 generated by the AI-based writing assistant. In some embodiments, framework 300, includes span detection and categorization prompt 310, LLM 320, and span edit prompt 330.

An LLM 320 may receive a span detection and categorization prompt 310. In some embodiments, LLM 320 may be any of those discussed herein or otherwise known to persons skilled in the art. Span detection and categorization prompt 310 may include an LLM-generated text 312 and example spans and categories 314. An example of a span detection and categorization prompt 310 is shown in Table 3, below. Span detection and categorization prompt 310, may include a list and explanation of the possible edit categories (e.g., cliché, tense inconsistency, etc.), one or more example spans and categories 314 from the LLM-generated response and edit dataset described herein, and one or more rules to guide LLM 320 in identifying problematic spans in the LLM-generated text 312.

TABLE 3
Span Detection and Categorization Prompt

You are given a paragraph of writing, and your goal is to provide feedback by selecting spans of text in the
writing that could be improved, and assign each problematic span to an error category. Below, we list the 7
error categories that you can choose from.
You are also provided 2 examples of paragraphs that were annotated by professional writers, which you can
use to better understand the task and the error categories.
Error Categories:
- “Awkward Word Choice and Phrasing”: Suggestions for better word choices or more precise phrasing to
enhance clarity and readability.
- “Cliche”: The use of hackneyed phrases or overly common imagery that lack originality or depth.
- “Poor Sentence Structure”: Feedback on the construction of sentences, recommending changes for better
flow, clarity, or impact.
- “Unnecessary/Redundant Exposition”: Redundant or non-essential parts of the text that could be removed/
rephrased for conciseness.
- “Lack of Specificity and Detail”: Need for more concrete details or specific information to enrich the text
and make it more engaging.
- “Purple Prose”: Identifying parts of the text that are seen as unnecessary ornamental and overly verbose.
- “Tense Consistency”: Comments pointing out inconsistencies in verb tense that need to be addressed for
uniformity.
Example 1: Input Text
Output:
Example Output in JSON format.
Example 2:
(Similar to example 1)
Rules:
- Number of Spans - You can provide feedback on multiple spans, and multiple spans can have the same
category.
- Span must be verbatim - The span you select must be verbatim from the paragraph, otherwise, the feedback
will not be provided to the user.
- No Overlap - Spans should not overlap, and one span should not include the other.
- Single Category - Each span should have exactly one category from the categories listed above.
Paragraph:
[LLM-generated text 312]

In some embodiments, a span detections and categorization prompt may be input to the LLM 320 for each paragraph in an LLM-generated text.

In response to the span detection and categorization prompt, LLM 320 may generate detected spans and categories 334. Detected spans and categories 334 include the sequences of words associated with a problematic span matching a category. Table 4 shows an example of problematic spans and their categories detected in a paragraph by LLM 320 using prompt 310. The problematic spans in Table 4 are contained in square brackets and the associated category for the problematic span is included as a subscript at the end of each span.

TABLE 4

| | |
|---|---|
| LLM- | Jackson leaned back in his office chair, staring out through the expansive glass |
| detected | windows of the high-rise building. Below him, the city [churned with relentless |
| spans and | energy_{Cliche}]. The city was [a tapestry of modernity threaded with the hum of traffic, |
| categories | the glow of digital billboards, and the unceasing flow of pedestrians_{Purple Prose}]. |
| | His desk, a [chaotic mixture of reports and coffee cups_{Cliche}] contrasted |
| | sharply with the sleek orderliness. [of the cityscape_{Cliche}]. Despite the apparent |
| | advancement that framed his daily life, Jackson felt an inexplicable |
| | [disconnection_{Cliche}] His mind often wandered to an untouched box of old |
| | photographs at home, depicting simpler times - [wooden houses, dirt paths, faces |
| | etched with stories of a bygone era._{Cliche}] He couldn't help but yearn for [the |
| | intangible warmth of community gatherings under open skies, unhurried |
| | conversations, and the tangible reality of a slower pace_{Purple Prose)}] Here, in the |
| | [heart of progress_{Cliche}], he was a mere observer, [detached from the legacy |
| | beneath the steel and concrete, his own inclinations buried beneath the layers of |
| | modernity._{Purple Prose)}] |

A span edit prompt 330 may be constructed from the detected spans and categories and example spans and edits 332. Tables 5-9 show the span edit prompt 330 for each of the edit categories. Each of the Tables 5-9 include instructions to the LLM 320 and examples of edits for each category.

TABLE 5
Rewriting Cliché

A cliché is a saying, idea, or element of an artistic work that has become overused to the point of
losing its original meaning or effect, even to the point of being weird, irritating, or bland.
You will be given example of 25 paragraphs with spans that count as Cliche and suggested edits that
either
**REWRITES THE CLICHE or SIMPLY REMOVES IT**
Your task will then be to suggest edits (either spans or empty string) that gets rid of the cliche while
making the resulting paragraph coherent, given a new paragraph and highlighted span of Cliche from
it. Do not simply paraphrase or use fancy ornamental language; Try to keep each sentence short. Look
at the examples carefully
**IT IS VERY IMPORTANT TO MAKE SURE THAT YOUR EDITED TEXT ONCE ADDED TO
THE PARAGRAPH READS COHERENTLY AND GRAMMATICALLY CORRECT.
For instance if you replace text within <span></span>tags with a longer span; please make sure the
following text after the edit, is its continuation. Simple way to ensure this is to make sure that the
edited span has the same casing and punctuation at the beginning and end as that of the original span.
PLEASE FOLLOW THE OUTPUT SCHEMA AS THE EXAMPLES BELOW AND DO NOT
RETURN ANYTHING OTHER THAN THE EDITED SPAN WITHIN QUOTES.
Example 1
Paragraph: Matthews had lived in the Valley all his life, and its rhythms and secrets were etched into
his being <span>like the lines on a well-worn map</span>. He knew [. . .]
Original Span: “like the lines on a well-worn map”
Edited Span: “like creases in an old pocket map”
Example 18
Paragraph: Husna sat at the ancient wooden [. . .] <span>The room was a bubble of quiet
concentration, the only sounds the clacking of the typewriter, the rustling of paper, and the occasional
whistle of the teakettle in the adjoining kitchen.</span>
Original Span: “The room was a bubble of quiet concentration, the only sounds the clacking of the
typewriter, the rustling of paper, and the occasional whistle of the teakettle in the adjoining kitchen.”
Edited Span: “The room was quiet. The outside world did not exist. At times, Husna tapped her foot.
Shah Sahib coughed and she would stop. The typewriter never did.”
Example 25
Paragraph: Last night, I dreamt of an [. . .] She didn't speak, but her eyes <span>communicated a
haunting mix of sadness and knowing, as if she held</span>the weight of forgotten secrets. I felt a
[. . .]
Original Span: “communicated a haunting mix of sadness and knowing, as if she held”
Edited Span: “conveyed”

TABLE 6
Rewriting Poor Sentence Structure

Poor sentence structure refers to writing that is difficult to understand or lacks clarity due to issues
with how sentences are constructed. It encompasses issues like run-on sentences, fragments,
misplaced or dangling modifiers, lack of variety, overuse of passive voice, improper parallelism, and
unclear pronoun references, all of which impede clear communication and reader comprehension.
You will be given example of 25 paragraphs with text within <span></span>tags that shows poor
sentence structure and suggested edits that either **REWRITES WITH IMPROVED SENTENCE
STRUCTURE**.
Your task will then be to suggest edits that rewrites the text within the span tags with better sentence
structure while making the resulting paragraph coherent, given a new paragraph and highlighted span
of poor sentence structure from it. Do not use fancy ornamental language; Look at the examples
carefully and do not output anything after closing quotes.
**IT IS VERY IMPORTANT TO MAKE SURE THAT YOUR EDITED TEXT ONCE ADDED TO
THE PARAGRAPH READS COHERENTLY AND GRAMMATICALLY CORRECT. For instance
if you replace text within <span></span>tags with a longer span; please make sure the following text
after the edit, is its continuation.
PLEASE FOLLOW THE OUTPUT SCHEMA AS THE EXAMPLES BELOW AND DO NOT
RETURN ANYTHING OTHER THAN THE EDITED SPAN WITHIN QUOTES
Example 4
Paragraph: <span>As the night wore on, Z.'s laughter grew louder, his words slurring together like a
sloppy melody. N. and I exchanged a knowing glance, our concern simmering beneath the
surface.</span> At first, it was just a slight stumble, a misstep that could be brushed off as a joke. [. . .]
Original Span: “As the night wore on, Z.'s laughter grew louder, his words slurring together like a
sloppy melody. N. and I exchanged a knowing glance, our concern simmering beneath the surface.”
Edited Span: “Z. was drinking more and more as the night went on. He laughed more loudly. His
words started to slur, blurring one into the next. I looked at N., who knew what I was thinking. We
were going to have to take care of him.”
Example 13
Paragraph: <span>As I step into the quiet, garden-facing room on the second floor, I'm struck by the
sense of stillness that pervades the space</span>. The occupants, an elderly couple, sit motionless in
their armchairs, their [. . .]
Original Span: “As I step into the quiet, garden-facing room on the second floor, I'm struck by the
sense of stillness that pervades the space”.
Edited Span: “A sense of stillness pervades the garden-facing room on the second floor”.
Example 25
Paragraph: Chef Amelia raced [. . .] <span>She plastered on a polite smile, determined not to let her
personal history interfere with her professional duties.</span>As Daniel approached, plate in hand,
Amelia steeled herself [. . .]
Original Span: “She plastered on a polite smile, determined not to let her personal history interfere
with her professional duties.”
Edited Span: “She shot a dutiful smile for anyone who was looking. This was an important night, and
she wasn't going to let the past get in the way of a job well done.”

TABLE 7
Rewriting Unnecessary or Redundant Exposition

Unnecessary or redundant exposition in writing refers to providing excessive explanatory information that
doesn't contribute meaningfully to the story, characters, or overall narrative.
You will be given example of 25 paragraphs with text within <span></span>tags that count as
unnecessary/redundant exposition and suggested edits that either **REWRITES IT IN FEWER WORDS
or SIMPLY REMOVES IT**.
Your task will then be to suggest edits that rewrites the text within the span tags correcting the unnecessary/
redundant exposition while making the resulting paragraph coherent, given a new paragraph and
highlighted text within of unnecessary/redundant exposition. Do not simply paraphrase or use fancy
ornamental language or repeat the same thing in the edited span; Look at the examples carefully.
**IT IS VERY IMPORTANT TO MAKE SURE THAT YOUR EDITED TEXT ONCE ADDED TO THE
PARAGRAPH READS COHERENTLY AND GRAMMATICALLY CORRECT.
For instance if you replace text within <span></span>tags with a shorter span; please make sure the
following text after the edit, is its continuation. Simple way to ensure this is to make sure that the edited
span has the same casing and/or punctuation at the beginning and end as that of the original span.
PLEASE FOLLOW THE OUTPUT SCHEMA AS THE EXAMPLES BELOW AND DO NOT RETURN
ANYTHING OTHER THAN THE EDITED SPAN WITHIN QUOTES
Example 2
Paragraph: In spring, when the first buds unfurled [. . .] embrace of varenyky dinners provided comfort
against the chill <span>, each bite narrating a history of resilience and hope</span>. It was through [. . .]
Original Span: “, each bite narrating a history of resilience and hope”
Edited Span: “”
Example 18
Paragraph: <span>As Oghi watched his mother-in-law, Mrs. Kim, he felt a subtle sense of unease settle in
the pit of his stomach.</span>It wasn't just the uncharacteristic behavior itself - [. . .]
Original Span: “As Oghi watched his mother-in-law, Mrs. Kim, he felt a subtle sense of unease settle in
the pit of his stomach.”
Edited Span: “Oghi watched his mother-in-law Mrs. Kim with heightening unease.”
Example 23
Paragraph: The small room [. . .] They teased and corrected each other's recollections <span>, creating a
tapestry of resilience and camaraderie</span>. It wasn't all smooth-sharp words resurfaced around old
wound, [. . .]
Original Span: “, creating a tapestry of resilience and camaraderie”
Edited Span: “”

TABLE 8
Rewriting Lack of Specificity and Detail

Lack of Specificity and Detail in writing refers to the absence of concrete and specific information, which can
make the text feel vague and unengaging. The need for more concrete details or specific information is crucial
to enrich the text and make it more engaging. Specificity helps to create vivid imagery, provides clarity, and
connects with the reader on a deeper level, doesn't contribute meaningfully to the story, characters, or overall
narrative.
You will be given example of 25 paragraphs with text within <span></span>tags that lacks specificity and detail
and suggested edits that either **REWRITES WITH SPECIFICITY AND DETAIL**.
Your task will then be to suggest edits that rewrites the text within the span tags with specificity and detail that
is engaging while making the resulting paragraph coherent, given a new paragraph and highlighted span of lack
of specificity and detail from it. Do not simply paraphrase or use fancy ornamental language; Look at the
examples carefully and do not output anything after closing quotes.
**IT IS VERY IMPORTANT TO MAKE SURE THAT YOUR EDITED TEXT ONCE ADDED TO THE
PARAGRAPH READS COHERENTLY AND GRAMMATICALLY CORRECT. For instance if you replace
text within <span></span>tags with a longer span; please make sure the following text after the edit, is its
continuation. Simple way to ensure this is to make sure that the edited span has the same casing and punctuation
at the beginning and end as that of the original span.
PLEASE FOLLOW THE OUTPUT SCHEMA AS THE EXAMPLES BELOW AND DO NOT RETURN
ANYTHING OTHER THAN THE EDITED SPAN WITHIN QUOTES.
Example 1
Paragraph: Sarah Mitchum's marriage appeared outwardly conventional, but subtle tensions simmered beneath
the surface. She and [. . .] leaving Sarah feeling increasingly isolated within her <span>own marriage.</span>
Original Span: “within her own marriage.”
Edited Span: “.Their marriage had run its course. There was no coming back.”
Example 15
Paragraph: <span>Dr. Arthur Steiger's fall from grace began with a series of whispered concerns among his
colleagues at Cormac General Hospital.</span>The small-town pain specialist had always been known [. . .].
Original Span: “Dr. Arthur Steiger's fall from grace began with a series of whispered concerns among his
colleagues at Cormac General Hospital.”
Edited Span: “Pain was Dr. Arthur Steiger's forte. Not inflicting it, that is, but resolving it. Whenever a patient
had problem, whether a tear in a tendon, a sprain, a knock, a headache, a broken bone- it was Dr. Steiger that
knew what to do.”
Example 21
Paragraph: Mila sat on her porch a week after the storm had hit, sipping lukewarm tea. [. . .] Each night <span>it
grew louder, shifting from a whisper to a groan, but she had dismissed it, too tired from long days at
work</span>. [. . .]
Original Span: “it grew louder, shifting from a whisper to a groan, but she had dismissed it, too tired from long
days at work”.
Edited Span: “lying like blanched spinach in her IKEA bed, trying not to think about another day of writing
emails with someone else's signature on them and pretending not to care what John Blanchett, CEO of Executive
Industries thought of her blouse-in other words, another day as John's executive assistant-”

TABLE 9
Rewriting Purple Prose

In literary criticism, purple prose is overly ornate prose text that may disrupt a narrative flow by drawing
undesirable attention to its own extravagant style of writing, thereby diminishing the appreciation of the prose
overall. Purple prose is characterized by the excessive use of adjectives, adverbs, and metaphors.
You will be given example of 25 paragraphs with text within <span></span>tags that has purple prose in it and
suggested edits that either **REWRITES THEM WITH SIMPLER WORDS OR REMOVES IT**.
Your task will then be to suggest edits that rewrites the text within the span tags altering the purple prose while
making the resulting paragraph coherent, given a new paragraph and highlighted span of purple prose from it.
Do not simply paraphrase or use fancy ornamental language; Look at the examples carefully and do not output
anything after closing quotes.
**IT IS VERY IMPORTANT TO MAKE SURE THAT YOUR EDITED TEXT ONCE ADDED TO THE
PARAGRAPH READS COHERENTLY AND GRAMMATICALLY CORRECT. For instance if you replace
text within <span></span> tags with a longer span; please make sure the following text after the edit, is its
continuation. Simple way to ensure this is to make sure that the edited span has the same casing and punctuation
at the beginning and end as that of the original span.
PLEASE FOLLOW THE OUTPUT SCHEMA AS THE EXAMPLES BELOW AND DO NOT RETURN
ANYTHING OTHER THAN THE EDITED SPAN WITHIN QUOTES.
Example 2
Paragraph: <span>Fruto never intended to stir anything beyond the melting pot of their weekly card
game.</span>But when the chatter turned to the dry monotony of their jobs, Fruto found himself blurting out,
[. . .] Original Span: “Fruto never intended to stir anything beyond the melting pot of their weekly card game.”
Edited Span: “Fruto hadn't meant to disrupt the routine of their weekly card game.”
Example 16
Paragraph: My mother cried, [. . . ] All of it vanished<span>, cycling back through her mind, not as numbers but
memories of scraped knees she bandaged alone and birthdays where her absence was felt more acutely than her
presence. The sobs emerged from this deep well of unspoken expectations, leaving behind a residue of weary
resilience and a few hopeful echoes yet unwilling to completely extinguish.</span>.
Original Span: “, cycling back through her mind, not as numbers but memories of scraped knees she bandaged
alone and birthdays where her absence was felt more acutely than her presence. The sobs emerged from this
deep well of unspoken expectations, leaving behind a residue of weary resilience and a few hopeful echoes yet
unwilling to completely extinguish.”
Edited Span: “She cried. She cried deep from this well of scraped knees she bandaged alone and birthdays she
missed to work. She cried for unfairness. She cried without relief.”
Example 24
Paragraph: <span>As they navigated their final year of high school, Maya and Jake found themselves at a
crossroads, their educational paths diverging like tributaries of a river.</span>[. . .]
Original Span: “As they navigated their final year of high school, Maya and Jake found themselves at a
crossroads, their educational paths diverging like tributaries of a river.”
Edited Span: “The final year of high school was pulling Maya and Jake in different directions.”

TABLE 10
Tense Inconsistency

Tense inconsistency in writing refers to the improper or unintended switching between different verb tenses
within a passage or sentence, which can confuse readers and disrupt the flow of the narrative.
You will be given example of paragraphs with text within <span></span> tags that has inconsistent tense in it and
suggested edits that either **REWRITES THEM WITH PROPER AND CONSISTENT TENSE**.
Your task will then be to suggest edits that rewrites the text within the span tags correcting the tense while
making the resulting paragraph coherent, given a new paragraph and highlighted span of inconsistent tense from
it. Do not simply paraphrase or use fancy ornamental language; Look at the examples carefully and do not output
anything after closing quotes.
**IT IS VERY IMPORTANT TO MAKE SURE THAT YOUR EDITED TEXT ONCE ADDED TO THE
PARAGRAPH READS COHERENTLY AND GRAMMATICALLY CORRECT. For instance if you replace
text within <span></span> tags with another span; please make sure the following text after the edit, is its
continuation. Simple way to ensure this is to make sure that the edited span has the same casing and punctuation
at the beginning and end as that of the original span.
PLEASE FOLLOW THE OUTPUT SCHEMA AS THE EXAMPLES BELOW AND DO NOT RETURN
ANYTHING OTHER THAN THE EDITED SPAN WITHIN QUOTES
Example 1
Paragraph: As I pulled into the driveway, the gravel crunched softly beneath the tires, and the warm glow from
the porch light cast an inviting halo in the dusky twilight. I noticed a woman standing by the garden, seemingly
lost in thought as she gently <span>fingered</span> the petals of a late-blooming rose. Her silhouette was
familiar, yet it took a moment for my mind to catch up. My heart raced, not with excitement but with a quiet
apprehension. She was my sister, Elena. I hadn't seen her since the night we argued and she stormed off in the
rain. She looked older now, wearier, as if each day away had carved its mark on her face. I killed the engine and
sat there, watching her for a moment. The realization of her return washed over me with a mix of relief and
uncertainty. What stories lay behind those tired eyes? What words would bridge the chasm of our years apart?
Original Span: “fingered”
Edited Span: “fingering”
Example 2
Paragraph: Husna sat at the ancient wooden desk in Shah Sahib's home office, the faint scent of
sandalwood <span>drifting</span> from the bookshelves. The typewriter in front of her was an archaic beast, its
keys slightly resistant under her fingers. Shah Sahib watched her from across the room, his eyes sharp yet kind,
offering occasional pointers through clipped sentences. The servant, an elderly man with a limp, moved quietly in
the background, arranging papers and dusting shelves with clinical precision. Each afternoon, he would bring in a
tray of tea and grilled-cheese toast, placing it near Husna with a slight nod, a ritual as consistent as the old clock
on the mantelpiece. Husna's method of typing was meticulous-each stroke deliberate, as if she were imprinting
not just words but meaning onto the page. Every now and then, she would pause and glance at Shah Sahib,
seeking approval or advice, both of which he gave sparingly. The room was a bubble of quiet concentration, the
only sounds the clacking of the typewriter, the rustling of paper, and the occasional whistle of the teakettle in the
adjoining kitchen.
Original Span: “drifting”
Edited Span: “drifted down”
Example 3
Paragraph: The sun hung low, casting long shadows over the boat as Luis and Mateo cast their lines near Morro
Castle. They had been silent for hours, save for the occasional murmur of encouragement or frustration. The fish
were elusive today, challenging their patience. The boat rocked gently in the ebb and flow of the tide<span>, the
water slapping softly against the wooden hull</span>. Around mid-morning, Luis felt the first tug on his line. It
was subtle but insistent, and he leaned forward, muscles tensing as he prepared to reel in. Mateo noticed and
moved quietly to his side, their unspoken camaraderie honed from years of fishing together. As Luis fought the
fish, they drifted slowly with the current, the boat edging closer to the National Hotel. The struggle played out in
a series of tense moments, the fish diving deep, Luis adjusting his technique, Mateo offering a steadying hand.
Finally, near the stately silhouette of the hotel, the fish broke the surface. It was larger than anticipated, a
glimmering testament to their effort. The line tautened, and with a final pull, they brought it aboard, both men
grinning in the muted twilight. It wasn't just a catch; it was a quiet victory etched into their routine, a shared
triumph amidst the enduring rhythm of the sea.
Original Span: “, the water slapping softly against the wooden hull”
Edited Span: “and the water slapped softly against the wooden hull”
Example 4
Paragraph: The sun hung low, casting long shadows over the boat as Luis and Mateo cast their lines near Morro
Castle. They had been silent for hours, save for the occasional murmur of encouragement or frustration. The fish
were elusive today, challenging their patience. The boat rocked gently in the ebb and flow of the tide, the water
slapping softly against the wooden hull. Around mid-morning, Luis felt the first tug on his line. It was subtle but
insistent, and he leaned forward, muscles tensing as he prepared to reel in. Mateo noticed and moved quietly to
his side, their unspoken camaraderie honed from years of fishing together. As Luis fought the fish, they drifted
slowly with the current, the boat edging closer to the National Hotel. The struggle played out in a series of tense
moments, the fish diving deep, Luis adjusting his technique, Mateo offering a steadying hand. Finally, near the
stately silhouette of the hotel, the fish broke the surface. It was larger than anticipated, a glimmering testament to
their effort. The line tautened, and with a final pull, they brought it aboard, both men <span>grinning</span> in
the muted twilight. It wasn't just a catch; it was a quiet victory etched into their routine, a shared triumph amidst
the enduring rhythm of the sea.
Original Span: “grinning”
Edited Span: “grinned”
Example 5
Paragraph: Dhoorre, a weathered shopkeeper in Mogadishu, had managed to keep his family's divided loyalties
secret for years. His eldest son, Abdi, worked as a low-level bureaucrat in the Transitional Federal Government,
while his younger son, Farah, had disappeared into the ranks of al-Shabaab. Dhoorre's careful silence protected
both sons from potential repercussions. <span>However, when</span> a local militia commander began
pressuring Dhoorre for information about Shabaab movements, the shopkeeper found himself cornered. In a
moment of desperation, he revealed Farah's name, hoping to gain some leverage or protection. This admission set
off a chain of events that threatened to unravel the delicate balance Dhoorre had maintained. The militia now
viewed him as a potential informant, while Shabaab sympathizers in the neighborhood grew suspicious. Abdi's
position in the government became precarious, as whispers of his brother's allegiance spread. Dhoorre realized
that his attempt to navigate the complex web of allegiances in Somalia had backfired, leaving his family exposed
to dangers from all sides. As tensions rose, he grappled with the consequences of his decision, knowing that the
fragile peace he had maintained for so long was now shattered.
Original Span: “However, when”
Edited Span: “One fateful afternoon”
Example 6
Paragraph: Dhoorre, a weathered shopkeeper in Mogadishu, had managed to keep his family's divided loyalties
secret for years. His eldest son, Abdi, worked as a low-level bureaucrat in the Transitional Federal Government,
while his younger son, Farah, had disappeared into the ranks of al-Shabaab. Dhoorre's careful silence protected
both sons from potential repercussions. However, when a local militia commander began pressuring Dhoorre for
information about Shabaab movements, <span>the shopkeeper</span> found himself cornered. In a moment of
desperation, he revealed Farah's name, hoping to gain some leverage or protection. This admission set off a chain
of events that threatened to unravel the delicate balance Dhoorre had maintained. The militia now viewed him as
a potential informant, while Shabaab sympathizers in the neighborhood grew suspicious. Abdi's position in the
government became precarious, as whispers of his brother's allegiance spread. Dhoorre realized that his attempt
to navigate the complex web of allegiances in Somalia had backfired, leaving his family exposed to dangers from
all sides. As tensions rose, he grappled with the consequences of his decision, knowing that the fragile peace he
had maintained for so long was now shattered.
Original Span: “the shopkeeper”
Edited Span: “and the shopkeeper”
Example 7
Paragraph: In the quiet of his bedroom, Liam lay still, his eyes fixed on the glow-in-the-dark stars scattered across
his ceiling. The faint hum of the air conditioner filled the room, a steady rhythm that usually lulled him to sleep.
But tonight was different. He strained his ears, hoping to catch a whisper of that familiar voice he longed to hear.
It had been months since he'd last heard it, and the absence gnawed at him. Liam wondered if he was somehow
choosing not to hear it, if his own doubts were drowning out the sound. He shifted in bed, his small frame barely
making an impression on the mattress. The night felt heavy, pressing down on him with questions he couldn't
answer. Who was he becoming in this silence? He closed his eyes, trying to picture the person he might be
when-if-the voice returned. As sleep finally began to creep in, Liam <span>found himself</span> caught
between wanting to stay awake and letting go, unsure which choice would bring him closer to understanding.
Original Span: “found himself”
Edited Span: “was”
Example 8
Paragraph: The small room was dimly lit by a single bulb, lending a cozy glow <span>that </span>softened the
lines on Marfa and Zinaida's faces. The two women sat opposite each other, nursing steaming cups of tea, their
eyes reflecting shared years and secrets. Marfa, with a half-smile playing on her lips, recalled their harebrained
scheme to sell homemade pickles at the winter market, a venture <span>that </span>ended in near disaster when
a stray dog knocked over their stall. Zinaida chuckled, retorting <span>that </span>it had been Marfa's idea to
place the samples so close to the edge. This disagreement, like many before, was laced with humor and affection.
The room filled with warmth as they descended into stories of ration lines, makeshift holidays, and late-night
confessions by the river. The laughter <span>that </span>erupted wasn't just about the memories they were
reliving, but also an acknowledgment of how those hardships had cemented their bond. They teased and corrected
each other's recollections, creating a tapestry of resilience and camaraderie. It wasn't all smooth-sharp words
resurfaced around old wound, about a lover lost and unsolicited advice. But even those sharp moments were
softened by time's passage, leading to a gentle, shared silence. The evening ended not with grand declarations but
a simple clinking of their cups, a toast to enduring friendship.
Original Span: “that”
Edited Span: “ ”
Example 9
Paragraph: As Shara approaches the boy's window, her excitement is tempered by a creeping sense of uncertainty.
She can't help but wonder if he'll even recognize her, considering she's still wearing the same outfit from their
initial encounter outside the TransAmerica building. The faded jeans and worn-out sneakers that had seemed so
insignificant then now feel like a beacon of vulnerability. What if he doesn't remember her, or worse, doesn't
care? The thought sends a shiver down her spine, and for a moment, she considers turning back, preserving the
fantasy of their connection rather than risking the harsh light of reality. But something about the way he had
looked at her, with a quiet intensity that had seen right through her defenses, propels her forward. She recalls the
way his eyes had crinkled at the corners, the gentle slope of his nose, and the softness of his voice. Still, doubts
linger. What if he's moved on, or was never truly invested in the first place? As she stands outside his window,
her heart <span>pounding</span> in her chest, Shara can't shake the feeling that she's about to expose herself, to
lay bare her deepest hopes and fears, and that the outcome is far from certain.
Original Span: “pounding”
Edited Span: “pounds”
Example 10
Paragraph: Augustus Blake woke up every morning at 5:30 AM, the weight of his responsibilities already bearing
down on him like a physical force. He'd <span>quietly get</span> dressed in the dark, careful not to disturb his
wife, Rachel, who worked the night shift at the hospital. After a quick breakfast, he'd head out to his job at the
mechanic's shop, where he'd toil for hours to make ends meet. The pay was meager, but it was honest work, and
Augustus took pride in being able to provide for his family. Still, the bills piled up, and the Blakes struggled to
make rent on their small apartment. Keisha, their bright and curious daughter, felt the strain acutely, sensing the
tension in her parents' hushed conversations about money. Her father's exhaustion was palpable, his eyes sunken
and his shoulders slumped as he trudged through the front door each evening. Despite the long hours, Augustus
always made time for his family, helping Keisha with her homework and listening to Rachel's stories about her
patients. But the financial struggles took their toll, and Augustus's dreams of opening his own shop seemed to
recede further with each passing month. As the days blended together, Augustus felt like he was drowning in a
sea of debt and responsibility, his own aspirations lost in the undertow. Yet, he kept going, driven by a fierce
determination to give his family a better life, even if it meant sacrificing his own.
Original Span: “quietly get”
Edited Span: “quietly”
Example 11
Paragraph: The earthquake struck without warning, transforming our quiet coastal town into a scene of chaos and
destruction. As buildings crumbled and the ground heaved beneath our feet, I found myself struggling to maintain
balance, my mind racing to process the sudden upheaval. In the aftermath, the air filled with dust and the cries of
those trapped in the rubble. I stumbled through the streets, my arm throbbing from a gash sustained during the
initial tremors, searching for familiar faces amid the confusion. The local hospital, overwhelmed with the injured,
set up makeshift triage centers in parking lots. As days passed, the true scale of the disaster became apparent,
with the death toll <span>climbing</span> steadily. Among the victims was Mrs. Chen, the elderly woman who
had lived next door to me for years, her absence leaving a palpable void in our tight-knit community. In the
weeks that followed, I often found myself pausing at her empty driveway, remembering the times she had shared
her homemade dumplings and stories of her childhood in a faraway land. The earthquake had not only reshaped
our physical landscape but also altered the fabric of our lives, leaving us to navigate a new reality shaped by loss
and resilience.
Original Span: “climbing”
Edited Span: “climbed”
Example 12
Paragraph: I took on the job of ghostwriting a memoir for a reclusive billionaire, enticed by the hefty paycheck
and the promise of a luxurious writing retreat on his private island. The project seemed straightforward: pour my
words into his life story, and collect my reward. But as I delved deeper into his world, I began to feel uneasy. The
billionaire's staff was tight-lipped and suspicious, and the island's isolation started to feel suffocating. The more I
learned about his life, the more I realized that his “rags-to-riches” tale was built on questionable business dealings
and exploited relationships. I struggled to reconcile my role in perpetuating his sanitized narrative with my own
moral compass. The writing itself became a chore, as I grappled with the weight of his secrets and the pressure to
produce a bestseller. One night, I stumbled upon a hidden folder on his computer, revealing a dark family tragedy
that he had kept hidden from the public eye. I felt like an accomplice, complicit in his deception. The luxurious
retreat now felt like a gilded cage, and I wondered if the financial benefits were worth the cost to my integrity. As
I sat at my desk, staring at the words that seemed to mock me, I knew I had to make a choice: finish the book and
collect my paycheck, or walk away and risk financial instability. The silence of the island seemed <span>to
closing</span> in around me, as I weighed the value of my words against the value of my conscience.
Original Span: “to closing”
Edited Span: “to close”
Example 13
Paragraph: Standing at the edge of the East River, I felt an unexpected calm amid the ever-pulsing city. The
water, dark and somewhat murky, held an odd kind of beauty in its relentless flow. The bridges stretching across
seemed less like feats of engineering tonight and more like quiet sentinels, subtly lit, watching over the water
below. A lone boat carved a slow, deliberate path, leaving a trail that quickly dissolved back into the river's
surface. I could see pockets of light <span>reflecting</span> from the scattered apartment windows, each glow
hinting at stories playing out unseen. The distant hum of traffic combined with the occasional bark of laughter
from somewhere along the bank, mixing into a soundtrack that was both comforting and alienating. There was
something soothing about the constant motion, as if the river was whispering that life would continue to move
forward, regardless of the countless little dramas unfolding around it. I found solace in that anonymity, that
vastness, sitting quietly at the boundary of immense human activity and the timeless, indifferent water.
Original Span: “reflecting”
Edited Span: “reflected”
Example 14
Paragraph: Daniel Handler's hands moved with an odd precision, <span>as</span> if counting each vertebra like
the pages of a book. The m<span>as</span>sage room smelled faintly of lemon and dust, an incongruous
combination that seemed fitting for the author's touch. As his fingers worked methodically down my spine, I felt a
strange mix of relaxation and une<span>as</span>e, <span>as</span> though my body were a puzzle being
slowly deciphered. The pressure varied unexpectedly - sometimes feather-light, other times startlingly firm -
mirroring the unpredictable nature of his writing. I found myself imagining each press and stroke
<span>as</span> a sentence, building a narrative I couldn't quite gr<span>as</span>p. The silence in the room
grew heavy, broken only by the occ<span>as</span>ional creak of the m<span>as</span>sage table and the soft
exhalations that escaped me involuntarily. Time seemed to stretch and contract, much like the muscles under
Handler's attentive hands. As the session progressed, I felt myself slipping into a state somewhere between
waking and dreaming, where half-formed ide<span>as</span> and fragments of stories floated just out of reach.
When it ended, I w<span>as</span> left with a lingering sense of having experienced something profound yet
intangible, like finishing a novel that refuses e<span>as</span>y interpretation.
Original Span: “as”
Edited Span: “were”
Example 15
Paragraph: As the inspector walked through the front door, she noticed the faint scent of stale cigarettes lingering
in the air. The living room appeared spacious, but the worn carpet and outdated wallpaper told a story of neglect.
Moving into the kitchen, she opened the cabinets, their hinges creaking with age, and found signs of water
damage beneath the sink. The bedrooms upstairs felt cramped, with low ceilings and small windows <span>that
allowed</span> little natural light to penetrate the gloom. In the master bathroom, the inspector's keen eye
spotted hairline cracks in the tiles and a slight slope in the floor, suggesting potential structural issues. As she
descended the stairs, a loose handrail wobbled beneath her grip. Stepping into the basement, the musty smell of
dampness assaulted her nostrils, and she noted the outdated electrical panel and rusting water heater. Outside, the
inspector navigated the overgrown lawn, discovering a cracked foundation hidden behind a dense shrub. The
fence surrounding the property leaned precariously, its paint chipped and peeling. Finally, she examined the roof,
finding missing shingles and evidence of past leaks. The property, once a family's cherished home, now stood as
a testament to the passage of time and the consequences of deferred maintenance.
Original Span: “that allowed”
Edited Span: “allowing”
Example 16
Paragraph: As the sun dipped below the horizon, Elliot found himself engulfed by the growing darkness on Route
7. The first snowflakes <span>began to drift</span> down from the heavens, gently kissing his face and
gradually blanketing the landscape in a pristine white. The world around him grew still, save for the soft crunch
of his footsteps and the whisper of the wind through the barren trees. Elliot pulled his coat tighter around himself,
seeking comfort in its warmth as the chill of the night seeped into his bones. His mind wandered to the events that
had led him to this lonely stretch of road, and a mixture of emotions swirled within him. Regret and longing
intertwined with a sense of determination, propelling him forward despite the uncertainty that lay ahead. As the
snow continued to fall, Elliot found solace in the beauty of the moment, the purity of the untouched snow a stark
contrast to the turmoil within his heart. He breathed deeply, the crisp air filling his lungs and clearing his
thoughts. With each step, he left behind the weight of his past, focusing instead on the promise of a new
beginning. The road stretched out before him, a blank canvas waiting to be painted with the colors of his future.
Elliot pressed on, his silhouette fading into the night as the snow continued to fall, blurring the lines between
earth and sky, between what was and what could be.
Original Span: “began to drift”
Edited Span: “drifted”
Example 17
Paragraph: The summer after Uncle Leo passed, I <span>remember sitting</span> on the porch and watching the
horizon where the sun melted into the earth, the same view we'd always shared. Spiker, the tabby cat he brought
home from one of his trips, curled at my feet. Spiker had aged too, his once fiery spirit dulled by grief or age-I
couldn't tell which. Uncle Leo's stories were a constant background music of my childhood, tales of wild
adventures that seemed too grand to fit in our small town. His absence left a strange void, a quietness that even
Spiker's purring couldn't fill. I found myself talking to Spiker more, as if he somehow held pieces of Uncle Leo
within him. The house now felt like a museum, where memories held court and echoed in the silence. At night,
I'd sometimes catch shadows playing tricks, shapes shifting in a way that reminded me of his animated gestures.
It was in these quiet, ordinary moments that I missed them most-not in the grand gestures, but in the details that
once went unnoticed.
Original Span: “remember sitting”
Edited Span: “sat”
Example 18
Paragraph: The summer after Uncle Leo passed, I remember sitting on the porch and <span>watching</span> the
horizon where the sun melted into the earth, the same view we'd always shared. Spiker, the tabby cat he brought
home from one of his trips, curled at my feet. Spiker had aged too, his once fiery spirit dulled by grief or age-I
couldn't tell which. Uncle Leo's stories were a constant background music of my childhood, tales of wild
adventures that seemed too grand to fit in our small town. His absence left a strange void, a quietness that even
Spiker's purring couldn't fill. I found myself talking to Spiker more, as if he somehow held pieces of Uncle Leo
within him. The house now felt like a museum, where memories held court and echoed in the silence. At night,
I'd sometimes catch shadows playing tricks, shapes shifting in a way that reminded me of his animated gestures.
It was in these quiet, ordinary moments that I missed them most-not in the grand gestures, but in the details that
once went unnoticed.
Original Span: “watching”
Edited Span: “watched”
Example 19
Paragraph: The summer after Uncle Leo passed, I remember sitting on the porch and watching the horizon where
the sun melted into the earth, the same view we'd always shared. Spiker, the tabby cat he brought home from one
of his trips, <span>curled</span> at my feet. Spiker had aged too, his once fiery spirit dulled by grief or age-I
couldn't tell which. Uncle Leo's stories were a constant background music of my childhood, tales of wild
adventures that seemed too grand to fit in our small town. His absence left a strange void, a quietness that even
Spiker's purring couldn't fill. I found myself talking to Spiker more, as if he somehow held pieces of Uncle Leo
within him. The house now felt like a museum, where memories held court and echoed in the silence. At night,
I'd sometimes catch shadows playing tricks, shapes shifting in a way that reminded me of his animated gestures.
It was in these quiet, ordinary moments that I missed them most-not in the grand gestures, but in the details that
once went unnoticed.
Original Span: “curled”
Edited Span: “lay curled”
Example 20
Paragraph: As Richard trails behind Bonita, he can't help but notice the way her hips sway with each step, her
heels clicking against the pavement in a steady rhythm. The night air is cool against his skin, and he tucks his
hands into his pockets, wondering what he's gotten himself into. Bonita leads him to a nondescript apartment
building, the bricks worn and the windows covered with heavy curtains. She unlocks the door and gestures for
him to follow her inside, a sly smile playing on her lips. The hallway is dimly lit, the walls lined with peeling
wallpaper and the air heavy with the scent of cigarette smoke. Bonita's apartment is on the third floor, and as they
climb the stairs, Richard's heart begins to race. He's not sure what to expect, but he knows that whatever happens
next will change everything. Bonita unlocks the door to her apartment and steps inside, kicking off her heels and
tossing her purse onto the couch. She turns to face Richard, her eyes dark and inviting, and he swallows hard, his
mouth suddenly dry. The apartment is small and sparsely furnished, but Richard barely notices his surroundings
as Bonita takes a step closer to him, her perfume filling his nostrils and <span>making</span> his head spin. She
reaches out and traces a finger along his jawline, her touch electric, and he knows that he's in trouble.
Original Span: “making”
Edited Span: “makes”
Example 21
Paragraph: In the quiet moments of introspection, Lindy found himself <span>grappling</span> with a profound
sense of longing, a yearning for a connection that transcended the superficial layers of everyday interactions. As
he sat alone, his thoughts drifted to the concept of being truly known by someone, a notion that simultaneously
filled him with both hope and trepidation. Lindy realized that the idea of allowing another person to see beyond
the carefully crafted façade he presented to the world was both exhilarating and terrifying. It meant vulnerability,
exposing the hidden corners of his soul, and risking rejection. Yet, deep within his heart, he recognized that the
potential for genuine understanding and acceptance was worth the gamble. Lindy's emotions swirled, a mix of
anticipation and apprehension, as he contemplated the transformative power of a connection built on authenticity.
He longed for someone who could see past his flaws and insecurities, someone who could embrace the entirety of
his being without judgment. In that moment, Lindy understood that the journey to find someone who truly knew
him would require courage, self-reflection, and a willingness to take a leap of faith. It was a path laden with
uncertainty, but one that held the promise of a profound and life-altering bond.
Original Span: “grappling”
Edited Span: “grappled”
Example 22
Paragraph: Alisa's year brimmed with a quiet joy that came from unexpected places. Her small, cozy apartment
buzzed with the sounds of new hobbies-painting, baking, and late-night jazz. It wasn't a grand life, but it was
hers, dotted with moments that felt like sunlight breaking through clouds. Alexander Yefimovich, an unassuming
librarian she had known for years, became an anchor in this tapestry of contentment. His subtle presence was a
calming influence; he never imposed, but always appeared when she needed help moving a heavy bookshelf or
<span>solving</span> a tricky crossword puzzle. His eyes held a certain kindness that reassured her on tough
days, a silent promise that she was not alone. Over time, their incidental meetings at the library evolved into a
dependable pattern, a kind of unspoken dance. Alexander's genuine interest in her well-being fostered a unique
sense of protection, not through grand gestures but through the simplicity of consistent, thoughtful actions.
Original Span: “solving”
Edited Span: “help solving”
Example 23
Paragraph: As Kay packed the last of her belongings into the moving van, a bittersweet mix of excitement and
trepidation swirled within her. Her father, silently <span>watching</span> from the porch, maintained his stoic
demeanor, yet the slight quiver in his lip betrayed his own inner turmoil. The house that had been her sanctuary
for so many years suddenly felt foreign, as if it had already begun to erase her presence. Kay's gaze drifted to the
worn swing set in the backyard, triggering a flood of memories-laughter, skinned knees, and the comforting
embrace of her father's arms. Now, as she prepared to embark on this new chapter, Kay couldn't help but question
whether she was truly ready to let go. Her father, in a rare display of vulnerability, pulled her into a tight hug,
whispering words of encouragement and pride. As Kay drove away, she glanced in the rearview mirror,
<span>watching</span> her father's figure grow smaller until he was nothing more than a speck in the distance.
The unfamiliar streets of her new neighborhood seemed to mock her uncertainty, but Kay steeled herself,
determined to embrace the challenges that lay ahead. As she unpacked her boxes in the empty apartment, the
silence felt both liberating and oppressive, a reminder of the independence she had craved and the loneliness she
feared. With each item she placed in its new home, Kay couldn't shake the nagging feeling that she was leaving a
piece of herself behind, a part that would always belong to the house with the creaky floorboards and the father
who loved her more than words could express.
Original Span: “watching”
Edited Span: “watched”
Example 24
Paragraph: Dylan stood in line at the corner coffee shop, waiting for his turn to order. The soft hum of
conversation buzzed around him as he tried to shake off the nagging feeling that he had forgotten something. It
wasn't until he reached the counter, the barista's patient smile reminding him to speak, that it hit him. He
mumbled his order, then stepped aside and pulled out his phone, realizing he had forgotten to send an important
email to his boss that morning. As he typed a quick, apologetic note, the friend he was meeting walked in,
greeting him with a cheer. Dylan forced a casual smile, sliding his phone back into his pocket, feeling the edges
of embarrassment prick his neck. “Sorry, just had to take care of something,” he said, hoping the slight tremble in
his voice went unnoticed. His friend just shrugged and started chatting about their weekend plans, unconcerned.
Dylan nodded along, sipping his coffee, the worry <span>ebbing</span> slightly with each word exchanged,
reassured by the normalcy of the mundane interaction.
Original Span: “ebbing”
Edited Span: “ebbed”
Example 25
Paragraph: Doug eased the car to a stop at the dusty gas station. The air shimmered with heat as he, Graham and
Lindsey climbed out, stretching their stiff legs. Cicadas droned in the surrounding trees. Doug headed inside to
pay while the others waited by the car. Graham lit a cigarette, shielding the flame with his hand. Lindsey leaned
against the hood, her forehead <span>glistening</span> with sweat. “We should grab some water,” she said,
squinting toward the shop. Graham nodded, exhaling a plume of smoke. The door jingled as Doug emerged
carrying a bag. He tossed Graham and Lindsey each a bottle of water before popping the gas cap. As the pump
hummed, they sipped the cold water in silence, the weight of the long drive settling heavily. When the tank was
full, Doug replaced the nozzle with a clang. They wordlessly piled back into the stifling car, a/c blasting as they
pulled out onto the scorching highway, the lonely station receding in the rearview mirror.
Original Span: “glistening”
Edited Span: “glistened”

TABLE 11
Tense Inconsistency

Awkward word choice and phrasing in writing refers to language use that sounds unnatural, clumsy, or difficult
to understand. It often results from selecting words that don't quite fit the context, using overly complex
structures, or failing to convey ideas clearly and concisely.
You will be given example of 25 paragraphs with text within <span></span> tags that has awkward word choice
and phrasing in it and suggested edits that either **REWRITES THEM WITH BETTER WORD CHOICE AND
PHRASING**.
Your task will then be to suggest edits that rewrites the text within the span tags improving the word choices and
phrasing while making the resulting paragraph coherent, given a new paragraph and highlighted span of awkward
word choice and phrasing from it. Do not simply paraphrase or use fancy ornamental language; Look at the
examples carefully and do not output anything after closing quotes.
**IT IS VERY IMPORTANT TO MAKE SURE THAT YOUR EDITED TEXT ONCE ADDED TO THE
PARAGRAPH READS COHERENTLY AND GRAMMATICALLY CORRECT. For instance if you replace
text within <span></span> tags with another span; please make sure the following text after the edit, is its
continuation. Simple way to ensure this is to make sure that the edited span has the same casing and punctuation
at the beginning and end as that of the original span.
PLEASE FOLLOW THE OUTPUT SCHEMA AS THE EXAMPLES BELOW AND DO NOT RETURN
ANYTHING OTHER THAN THE EDITED SPAN WITHIN QUOTES
Example 1
Paragraph: Sarah had always known her father's hardware store would one day be hers, but she never expected
the path to inheritance would involve a mop and nametag. At her father's insistence, she found herself working as
“Amy,” a new hire in the store's janitorial staff. Her co-workers, unaware of her true identity, treated her with a
mix of indifference and casual friendliness. Sarah's father, Mr. Grayson, watched from his office, expecting his
daughter to prove her worth through hard work and perseverance. As days turned to weeks, Sarah <span>found
herself caught</span> between two worlds: the familiar aisles she'd grown up in and the unfamiliar perspective of
an entry-level employee. She noticed things she'd never seen before - the strain on the cashiers' faces during rush
hours, the way certain products always seemed to be misplaced, and the camaraderie that formed in the break
room. Mr. Grayson remained stoic, offering no praise or criticism, leaving Sarah to wonder if she was meeting his
unspoken standards. As her hands grew calloused and her understanding of the business deepened, Sarah began to
question whether the promise of inheritance was a gift or a burden, and if the store she thought she knew was the
same one she was now experiencing from the ground up.
Original Span: “found herself caught”
Edited Span: “oscillated”
Example 2
Paragraph: I was sitting at the kitchen table, thumbing through brochures of Alaskan landscapes, imagining the
crisp air and untamed wilds, when my mother walked in. She stood there for a moment, hands on her hips, eyes
soft but resolute. She cleared her throat, and I knew something was coming. “Aggie needs help,” she said, her
voice low but urgent. My grip on the brochure tightened <span>involuntarily</span>. “Who's Aggie?” I asked,
even though I vaguely remembered the name. “A friend,” she replied, but that word carried a weight I couldn't
quite place. She explained quickly, how Aggie had fallen on hard times, how she had nobody else to turn to. I
looked at my mother, seeing the unspoken plea in her tired eyes. She didn't have to say it, but I knew-this was
important to her. I stuffed the brochure back into my bag, the dreams of Alaskan adventure crumpling slightly
like the paper. “Okay, I'll help,” I conceded, trying to mask the twinge of disappointment. My mother smiled, a
mix of relief and gratitude, and I felt the familiar tug of family obligations reeling me back in.
Original Span: “involuntarily”
Edited Span: “”
Example 3
Paragraph: The late afternoon sun cast long shadows across the neat rows of books in the small town library. For
a moment, I stood still, basking in the quiet assurance of this space that felt more like home than my own
cluttered apartment. My fingers trailed along the spines, the smell of aged paper and ink<span> filling my
senses</span>. Halfway down a forgotten aisle, a soft thud caught my attention-a book had mysteriously fallen
off a crooked shelf. It was an old leather-bound volume, worn from years of handling. I had never seen it before,
and something about its presence struck me as important, like a whisper from the past meant only for me. Picking
it up, I felt the weight of its history and wondered about the countless hands that had held it. Opening the first
page, I found a faded note tucked inside, barely legible but enough to spark a sense of connection to a distant
stranger. Each word seemed to pull me deeper into a quiet investigation, making me question what kind of life
had warranted this hidden message. There, in that sanctuary of books, I felt both secure in my solitude and
curious about the lives that had woven this delicate web of forgotten memories.
Original Span: “filling my senses”
Edited Span: “”
Example 4
Paragraph: As I set out on my cross-country journey, the frozen landscape of Normal, Illinois, stretched out
before me like a barren wasteland. The snow-covered roads <span>seemed to shimmer</span> in the pale winter
sun, and I felt a shiver run down my spine as I navigated the desolate highways. The GPS led me through a series
of small towns, each one blending into the next like a forgotten melody. I stopped for coffee in a dingy diner,
where the waitress's tired eyes seemed to hold a thousand stories. The coffee was bitter, but it warmed my hands
as I continued west. Hours blurred together, the only sound the soft hum of the engine and the occasional crackle
of the radio. As the sun began to set, I spotted a sign for Indianapolis, and my heart quickened with the promise
of civilization. But it wasn't until I pulled into the parking lot of the Holiday Inn that I realized I'd stumbled into
something unexpected. The lot was packed with hot rods, their gleaming bodies and revving engines a jarring
contrast to the frozen landscape I'd left behind. I checked in, feeling like an outsider among the rowdy
convention-goers, and made my way to the bar. Over a whiskey, I struck up a conversation with a gruff but kind-
hearted mechanic, who regaled me with stories of engines and speed. As the night wore on, I found myself drawn
into the vibrant world of hot-rodders, their passion and camaraderie a welcome respite from the lonely miles I'd
traveled.
Original Span: “seemed to shimmer”
Edited Span: “shimmered”
Example 5
Paragraph: Benny Avni stood at the threshold of the quietly bustling synagogue, his hand lingering on the
doorknob. The familiar hum reached his ears, an odd comfort amidst his internal disquiet. He stepped inside,
nodding at Mr. Kaplan, who was adjusting the heavy curtains by the windows, their creases casting sharp lines
across the wooden floor. Benny's eyes flitted over the congregation-faces half-lit by candles, illustrating hope
and worry in equal measure. He slid into a pew near the back, where the scent of worn leather and dusty prayer
books mingled. Outside, heavy clouds began to gather, seen through the tall windows, threatening a downpour.
Benny watched as a child draped in a prayer shawl peered out at the darkening sky, momentarily distracted from
his family's whispered prayers. The elder rabbi's voice began the evening's service, <span>gentle but firm,
drawing everyone's attention forward</span>. Benny's thoughts wandered to the alley behind the building, where
he had seen a stray cat darting between trash bins, seeking warmth. The cat mirrored his own feelings of
displacement, he mused, as he half-heartedly joined in the response. As the service moved on, he found himself
repeatedly glancing toward the door, caught in a web of belonging and escape. It struck him, in that quiet
moment, how the synagogue was a refuge not just from the impending rain, but from the storms inside him.
Original Span: “gentle but firm, drawing everyone's attention forward”
Edited Span: “his small frame commanding the room's attention”
Example 6
Paragraph: Aryeh Zelnik's life had been a series of carefully constructed dominoes, each one precision-placed to
<span>create a sense of order and control</span>. He had a thriving career as a software engineer, a comfortable
apartment in the city, and a social circle that, while not particularly close, was at least reliable. But it was all a
facade. The stress of meeting deadlines, the pressure to constantly innovate, and the superficiality of his
relationships had taken its toll. The final blow came when his company downsized, and Aryeh found himself
among the laid-off. The loss of his job was a catalyst, exposing the emptiness he had been trying to fill with
distractions. As he struggled to find a new sense of purpose, his mother, who had been living in Tel Ilan, a small
town in the countryside, suffered a minor stroke. Aryeh felt a pang of guilt and responsibility, realizing he had
been neglecting her. He decided to move in with her, hoping to care for her and, in the process, rediscover
himself. The slower pace of life in Tel Ilan was a balm to his frazzled nerves, and he began to crave a simpler
existence. As he settled into his mother's house, surrounded by the familiar comforts of his childhood, Aryeh
started to let go of his need for control, embracing a life of quiet contemplation. He stopped checking his phone
every five minutes, stopped worrying about his career trajectory, and started to listen to the silence. It was a
tentative step towards a life of absolute relaxation, one that was both terrifying and exhilarating.
Original Span: “create a sense of order and control”
Edited Span: “fall seamlessly into the next”
Example 7
Paragraph: Sarah found herself pausing in the grocery store aisle, her hand hovering over a jar of olives. The
label, with its sun-drenched Greek coastline, transported her back to that little taverna in Santorini. It wasn't the
grand moments of her trip that lingered, but these tiny, unexpected reminders. The faint whiff of lavender from
her neighbor's garden <span>conjured</span> images of purple fields in Provence. A stranger's laughter on the
subway echoed the carefree giggles of backpackers she'd met in a Barcelona hostel. Even the peso coin she'd
accidentally used in a parking meter last week felt like a small rebellion against the mundane routines she'd
slipped back into. These fragments of her travels weren't just memories; they were lifelines to a version of herself
she feared losing in the day-to-day grind. Sarah realized that perhaps the true value of travel wasn't in the
moments experienced, but in how those moments continued to shape her long after she'd returned home. She
placed the olive jar in her cart, a small act of defiance against forgetting, and continued down the aisle with a
slight spring in her step.
Original Span: “conjured”
Edited Span: “brought back”
Example 8
Paragraph: By New Year's, Joey had settled into a comfortable routine at Carol and Blake's place. He'd found a
part-time job at a local bookstore, which gave him a<span> sense of </span>purpose and allowed him to
reconnect with his love of literature. Carol, a freelance writer, took him under her wing, offering valuable writing
tips and introducing him to her publishing contacts. As they worked on their respective projects, Joey and Carol
developed a strong bond, with Carol becoming a mentor and confidante. Blake, a graphic designer, taught Joey
the basics of design software, and they spent hours working on projects together, their creative energies feeding
off each other. Joey's relationships with his hosts deepened, and he began to see them as a surrogate family.
However, as he grew closer to Carol and Blake, he struggled to reconcile his feelings of gratitude with his
lingering<span> sense of </span>guilt and shame. He started to open up about his past, sharing fragments of his
story with Carol, who listened with empathy and understanding. Joey's behavior evolved as he learned to trust
himself and others, slowly shedding his defensive armor. He began to take risks, attending writing workshops and
submitting his work to literary magazines. Despite the occasional setback, Joey's confidence grew, and he started
to envision a future beyond his troubled past. As the New Year's Eve party approached, Joey felt a<span> sense
of </span>belonging he hadn't experienced in years, and he knew that Carol and Blake's place had become a
sanctuary, a place where he could heal and rediscover himself.
Original Span: “sense of”
Edited Span: “ ”
Example 9
Paragraph: At the <span>bustling</span> gallery opening, amid laughter and clinking glasses, Marcus stood
beside a vibrant abstract painting, his expression as blank as the canvas had once been. A woman, intrigued by
the sternness of his posture, approached with a warm smile, but Marcus barely glanced her way, offering no more
than a flat “hello.” He remained statuesque, even as clusters of friends and acquaintances drifted past, bestowing
greetings and raising their glasses towards him. Every question was met with a monosyllabic answer, every
gesture of camaraderie ignored. His eyes glazed over the art, the conversations, the faces around him, as though
he were encased in a glass box that muted the world outside. Attempts at humor, personal stories, even a gentle
tap on the shoulder, rolled off him like water off stone. Someone whispered it was his own exhibit, but that only
added a layer of enigma. The festive atmosphere moved around him effortlessly, mistaking his silence for
contemplation or perhaps even arrogance, though not one presumption pierced the unspoken barrier he upheld.
Even in a room teeming with life, Marcus remained an island unto himself, as if he were waiting for a moment
that had long since passed.
Original Span: “bustling”
Edited Span: “”
Example 10
Paragraph: Dad's self-perception was <span>a complex tapestry, </span> woven from threads of pride, insecurity,
and a dash of humor. He saw himself as a rugged, no-nonsense guy who'd weathered life's storms, but beneath the
gruff exterior, he was acutely aware of his physical limitations. At 52, he'd recently started taking his fitness
routine more seriously, not to impress anyone, but to prove to himself he still had it in him. Three times a week,
he'd hit the gym, methodically working his way through a regimen of weights and cardio, his eyes fixed on the
mirror, critiquing every rep. His age was a constant companion, a reminder that time was slipping away, but he
refused to let it define him. As a personal trainer, he'd built a reputation for being tough but fair, pushing his
clients to their limits while sharing hard-won wisdom. At the gym, he was “Coach,” a title that brought a sense of
purpose and authority. Yet, in quiet moments, he wondered if he was still relevant, if his message was getting lost
in the noise of younger, more charismatic trainers. Despite these doubts, he persisted, driven by a deep-seated
need to make a difference, one sweat-drenched session at a time. His profession had become an extension of
himself, a way to leave a mark on the world that went beyond his own mortality. As he wrapped up each workout,
he'd glance in the mirror, searching for the man he used to be, and, more often than not, finding a glimmer of him
still there, refusing to fade away.
Original Span: “a complex tapestry,”
Edited Span: “complexly”
Example 11
Paragraph: As I walked into the <span>dimly lit</span> living room, the familiar scent of pine and sugar cookies
enveloped me, but it was the gathering itself that was utterly transformed. My aunt, a statuesque deer with
piercing brown eyes, effortlessly juggled three sugar cookies while regaling my cousin, a mischievous raccoon,
with stories of her latest art projects. Nearby, my uncle, a gruff but lovable bear, grumbled good-naturedly as he
wrestled with the Christmas tree lights, his fur fluffed up in frustration. My sister, a sleek and agile cat, lounged
on the windowsill, her tail twitching with excitement as she chatted with our grandmother, a wise and gentle owl
perched on the armchair. Meanwhile, my brother, a gangly and enthusiastic giraffe, bounded around the room,
distributing homemade ornaments to the assembled family members. As I made my way through the room, I
caught snippets of conversation: my mother, a soft-spoken rabbit, discussing the latest neighborhood gossip with
my father, a wry and witty fox; my cousins, a trio of rambunctious monkeys, arguing over the best way to eat a
candy cane. Despite the initial shock of seeing my loved ones transformed into creatures, the scene felt strangely
natural, as if this was how we'd always been meant to gather. As I took a seat on the couch, a gentle nudge from
my deer aunt reminded me to pass the cookies, and I felt a deep sense of belonging amidst this surreal, yet
somehow utterly ordinary, Christmas gathering.
Original Span: “dimly lit”
Edited Span: “dim”
Example 12
Paragraph: Nirmala is the university librarian, a quiet woman with a discerning eye for detail and an uncanny
ability to remember everyone's name-a rare skill in the transient world of academia. Her kindness is subtle but
steadfast; she has an instinct for when a student is struggling, offering a cup of tea or recommending a book that
seems to speak directly to their problems. The foreign graduate students often find solace in her presence, feeling
seen in a place where they frequently feel invisible. She keeps a well-tended shelf of international literature,
always stocked with contemporary titles from students' home countries, making the library feel a bit closer to
home. Without making a show of it, Nirmala organizes monthly meetups where students can exchange ideas and
stories in their native languages. Her actions aren't grand gestures but small, consistent acts that <span>sew a web
of</span> connection. It's these quiet efforts, her steadfast reliability, and the seemingly effortless way she
creates a haven amid the chaos of university life, that make her beloved among the foreign graduate students.
Original Span: “sew a web of”
Edited Span: “fosters”
Example 13
Paragraph: Everything started to unravel for Bruno the morning he and Cynthia had their argument. She had
accused him of neglect and he had countered with accusations of his own, neither hearing the other. Shaking from
the confrontation, Bruno went to Keith for solace but found him too preoccupied with his own troubles to provide
any. Keith's distant demeanor made Bruno feel abandoned, silently confirmed that his recent missteps had roots
he couldn't untangle. With his mind clouded, Bruno made rushed, ill-considered moves in the market, and one by
one, they backfired. The once calculated risk-taker found himself bleeding Singapore dollars, each loss a tangible
confirmation of his spiraling state. Yet, with each dollar that slipped away, came an unexpected sense of
liberation. The crumbling facade of his financial security mirrored the cracks in his relationships, and as his
numbers dwindled, so did the pressure to maintain them. By losing, Bruno was released from a game where
Cynthia and Keith were inscrutable opponents, and for the first time, <span>he felt an unspoken permission to
admit</span> he needed a way out.
Original Span: “he felt an unspoken permission to admit”
Edited Span: “he could admit”
Example 14
Paragraph: Cecilia walked beside the group of women, their conversation shifting seamlessly from gossip to
whispers of the old house on Sycamore Street. They spoke of the cat-a spectral figure that <span>seemed to
guard</span> the decaying place with an unearthly wisdom. Cecilia listened, piecing together fragments; the cat's
eyes glowed in the dark, they said, as if it bore witness to the house's secrets. She couldn't help but notice how
their voices would lower when the house was mentioned, as though it demanded reverence or perhaps distance.
Cecilia wondered if the tales were town folklore or if there was something more personal, more visceral, in their
cautious tones. Each woman's face held a shadowed look, marked by a mixture of curiosity and fear. The more
she observed, the more Cecilia felt an invisible thread linking her to that derelict house-and the enigmatic cat.
As the group dispersed, she caught the eye of one woman, who gave her a knowing nod, as if the house had
chosen Cecilia as its next subject.
Original Span: “seemed to guard”
Edited Span: “guarded”
Example 15
Paragraph: In the dimly lit cell, Pancho and Caesar faced off, their animosity palpable. The <span>air was thick
with the weight of past grievances, </span> and Pancho's eyes seemed to hold a deep sadness. He had once been a
leader, respected and feared, but a tragic mistake had cost him everything. Caesar, a ruthless opportunist, had
exploited Pancho's downfall, and now the two were trapped in this cramped, suffocating space. As they circled
each other, Pancho's thoughts drifted back to the family he had wronged, the loved ones he had failed. He saw
their faces in Caesar's, and his anger gave way to a desperate longing for redemption. Caesar, sensing weakness,
pounced, but Pancho refused to back down. With a heavy heart, he fought back, not to win, but to prove to
himself that he still had a spark of decency left. As the blows landed, Pancho's past mistakes replayed in his mind,
fueling his determination to make amends. In the end, it was not strength or aggression that decided the outcome,
but Pancho's willingness to confront his demons and take responsibility for his actions. As Caesar lay defeated,
Pancho stood over him, his eyes filled with a mix of sorrow and resolve, knowing that this small victory was only
the beginning of his journey towards redemption.
Original Span: “air was thick with the weight of past grievances,”
Edited Span: “air burned with resentment,”
Example 16
Paragraph: On New Year's Eve, the inmates gathered in their usual silence near the cell block windows. The noise
from the city outside seeped through the thick glass, a faint reminder of freedom. Amidst the distant bursts of
fireworks, they noticed her-a woman standing alone on the corner beneath a<span> flickering</span>
streetlamp. Her coat, too thin for the winter chill, hugged her tight, and she glanced around as if expecting
someone. Unease washed over the watchers, their breath fogging the glass as they huddled closer. Each man
filled the silence with his own story about her, piecing together fragments of their pasts and shattered
connections. She pulled out a phone, the screen's blue glow highlighting her anxious face, but no call came. As
midnight crept closer, the inmates exchanged looks, the unspoken realization settling in: she wasn't meeting
anyone; she was waiting to be missed-just like they were. When the final countdown began and the city erupted
in cheer, she lowered her head and walked away, leaving behind the dim streetlight and a sense of profound
silence that resonated more deeply than any celebration.
Original Span: “flickering”
Edited Span: “”
Example 17
Paragraph: It was one of those nights where the darkness felt palpable, like a physical presence that refused to let
me escape. I lay there, <span>my mind racing with thoughts</span> of my sister, who was going through a tough
breakup. I couldn't shake off the feeling of helplessness, wondering if she'd ever find her way back to happiness.
My thoughts drifted to my niece, who was struggling in school, and the weight of responsibility I felt as her
guardian. I worried about my best friend, who was chasing a dream that seemed increasingly elusive. As the
hours ticked by, my fears began to morph into hopes - hopes that my sister would find a love that would heal her,
that my niece would discover her hidden talents, and that my friend would finally get his big break. But beneath
those hopes, I knew there was a deeper fear - that I wouldn't be able to protect them, that I wouldn't be enough.
The more I thought about it, the more I realized that my hopes and fears were inextricably linked, like two sides
of the same coin. It was a fragile balance, one that I struggled to maintain. As the first light of dawn crept in, I
finally drifted off to sleep, exhausted but also strangely at peace. It was as if the darkness had given me a glimpse
of the truth - that love and worry were two sides of the same coin, and that the only way to truly care for others
was to confront my own limitations.
Original Span: “my mind racing with thoughts”
Edited Span: “thinking”
Example 18
Paragraph: As I sat in the hospital waiting area, the fluorescent lights overhead cast an unforgiving glare on the
rows of worn, vinyl chairs. The air was thick with the scent of stale coffee and disinfectant, a potent reminder of
the fragility of human life. To my left, a young mother clutched her whimpering infant, her eyes red-rimmed from
lack of sleep. Across from me, an elderly man with a wispy comb-over flipped through a worn copy of People
magazine, his eyes darting towards the door every few minutes, as if willing his loved one to emerge. A soft
murmur of hushed conversations and rustling newspapers filled the space, punctuated by the occasional beep of a
pager or the soft whoosh of the automatic doors. A bank of vending machines hummed in the corner, offering a
meager selection of snacks and drinks to the anxious and the weary. Near the entrance, a volunteer in a bright
pink jacket pushed a cart loaded with dog-eared paperbacks and wilted flowers, her forced smile a stark contrast
to the somber atmosphere. Amidst the sea of strangers, I noticed a few clusters of family members, their faces
etched with worry and fatigue, their eyes locked on the door that led to the ICU. The sound of footsteps echoed
down the corridor, growing louder and then fading away, a constant reminder that time was ticking. As I waited,
the silence between the sounds began to feel like a living, breathing entity, a <span>palpable</span> presence
that hung in the air like a challenge.
Original Span: “palpable”
Edited Span: “”
Example 19
Paragraph: In the wealthy and influential Langley family, appearances were everything. Behind the perfectly
manicured lawn and gleaming facade of their estate, 25-year-old Emma was suffocating under the weight of her
family's expectations. Her parents, both high-society pillars, had always pushed her to present a united front, to
never show weakness or vulnerability. So when Emma's mother was diagnosed with a debilitating illness, Emma
<span>was coached to downplay her own fears and sadness</span>, to put on a brave face for the sake of the
family's reputation. Her parents' friends and acquaintances would often ask how she was coping, and Emma was
encouraged to respond with a bright, “I'm doing great, Mom's doing great, we're all just so grateful for the
support!” - even when the truth was that she was barely holding it together. As the months went by, Emma found
herself trapped in a web of half-truths and omissions, struggling to reconcile her genuine emotions with the
artificial persona she was forced to project. Her relationships with her parents and siblings began to fray, as they
too were caught up in the charade. The pressure to conform was suffocating, and Emma began to wonder if
anyone would even notice if she disappeared behind the mask of perfection.
Original Span: “was coached to downplay her own fears and sadness”
Edited Span: “swallowed her own grief”
Example 20
Paragraph: The sun <span>hung low, casting</span> long shadows over the boat as Luis and Mateo cast their
lines near Morro Castle. They had been silent for hours, save for the occasional murmur of encouragement or
frustration. The fish were elusive today, challenging their patience. The boat rocked gently in the ebb and flow of
the tide, the water slapping softly against the wooden hull. Around mid-morning, Luis felt the first tug on his line.
It was subtle but insistent, and he leaned forward, muscles tensing as he prepared to reel in. Mateo noticed and
moved quietly to his side, their unspoken camaraderie honed from years of fishing together. As Luis fought the
fish, they drifted slowly with the current, the boat edging closer to the National Hotel. The struggle played out in
a series of tense moments, the fish diving deep, Luis adjusting his technique, Mateo offering a steadying hand.
Finally, near the stately silhouette of the hotel, the fish broke the surface. It was larger than anticipated, a
glimmering testament to their effort. The line tautened, and with a final pull, they brought it aboard, both men
grinning in the muted twilight. It wasn't just a catch; it was a quiet victory etched into their routine, a shared
triumph amidst the enduring rhythm of the sea.
Original Span: “hung low, casting”
Edited Span: “threw”
Example 21
Paragraph: Marciano sat alone at the corner of the dimly lit bar, nursing a whiskey he had barely touched. The
room buzzed with the low hum of conversations, laughter punctuating the air now and then. He fidgeted with a
napkin, his eyes distant, as if searching for something just out of reach. A group of young men stumbled in, their
loud jokes and boisterous energy starkly contrasting Marciano's quiet demeanor. One of them, a broad-shouldered
guy with a crooked smile, intentionally bumped Marciano's table, causing his drink to spill. <span>Marciano's
jaw tightened</span>, but he said nothing, staring down at the amber liquid pooling on the scratched wood. The
bartender, a middle-aged woman named Clara with eyes that saw too much, noticed the incident from across the
room. She walked over without a word, her movements efficient and calm. She handed Marciano a fresh glass of
whiskey and mopped up the spill with a practiced hand. The clinking of glass against wood broke the tension, and
Marciano looked up, meeting Clara's steady gaze. There was no pity in her eyes, just a quiet understanding. She
gave him a barely perceptible nod before turning away to handle another patron. Marciano straightened up
slightly, the tightness in his chest easing. He picked up the new glass, no longer feeling as alone as he did a
moment before.
Original Span: “Marciano's jaw tightened”
Edited Span: “Marciano felt a wave of anger”
Example 22
Paragraph: I was seventeen when I discovered my mother's quiet strength, the kind that isn't obvious in daily
routines or casual conversations. It was a blistering summer day, the kind that saps your energy just by existing,
and the air conditioning in the house had given up. My mother didn't complain, though we were all sticky and
irritable. Instead, she pulled out an old radio, tuned it to a jazz station, and started making lemonade from the
bruised lemons in the fridge. I watched her move around the kitchen, her ponytail swaying as she hummed with
the music. She took that moment, suffused with heat and discomfort, and transformed it into something bearable,
almost sweet. When she handed me a glass, her fingers were cool and her eyes were calm, unwavering. That's
when I saw her, really saw her-more than just a mother but <span>a woman who navigated life's relentless
grind with grace. </span> Her attractiveness was in how she handled adversity with an understated elegance,
reframing ordinary life into something more, without ever asking for recognition. In that moment, I understood
the depth of her resilience and felt a newfound admiration that stretched beyond the bounds of familial
expectation.
Original Span: “a woman who navigated life's relentless grind with grace.”
Edited Span: “she was a woman of inordinate grace”
Example 23
Paragraph: The door creaked open, and the murmur of the bar momentarily dwindled as the homeless man
shuffled in, his layers of tattered clothing rustling with each hesitant step. He made his way to the bar, where the
barmaid, engrossed in wiping down glasses, looked up with practiced detachment. The pair of sunglasses in her
tip jar caught his eye, <span>incongruously pristine</span> against the spare dollar bills and pocket change.
“Left 'em here last night,” she said, noticing his gaze. He nodded, not in understanding but acknowledgment. She
slid a glass of water his way, no questions asked, just a silent agreement that this was their exchange-a gesture
of dignity for a fleeting moment of warmth. The sunglasses' reflection glinted, capturing for an instant the world
outside, one he once knew intimately. He gave a small, almost imperceptible smile, and she returned to her work,
both aware, yet choosing to ignore, that some encounters leave impressions deeper than words.
Original Span: “incongruously pristine”
Edited Span: “pristine”
Example 24
Paragraph: The dimly lit bar buzzed with <span>the hum of</span> quiet conversations, laughter, and the
clinking of glasses. As I scanned the room, I noticed a woman sitting alone at the far end, her hunched posture
and the way she nursed her drink hinting at solitude. Her appearance was plain and almost seemed to render her
invisible amid the vibrant night crowd. Avoiding her gaze, I found a seat on the opposite side, feeling a pang of
guilt for my hesitance. I ordered my drink, trying to immerse myself in my thoughts, when I sensed a presence
beside me. Turning slightly, I saw her standing there, a hesitant smile playing on her lips. “Hi,” she said softly,
her voice carrying an unexpected warmth. I straightened up, attempting to mask my surprise and discomfort with
a polite nod. She introduced herself and began to talk, her words weaving stories that soon filled the space
between us, dissolving the initial awkwardness. As the conversation flowed, I realized her charm lay not in what
met the eye but in the quiet wisdom and humor she exuded.
Original Span: “the hum of”
Edited Span: “”
Example 25
Paragraph: On a typical Tuesday evening, Mary and Thomas settle into their routine, each lost in their own
thoughts as they navigate the quiet hours after dinner. Mary, an illustrator, sits at her desk, surrounded by half-
finished sketches and crumpled paper, her mind still racing from a meeting with a potential new client earlier that
day. Thomas, an engineer, reclines on the couch, his eyes fixed on the TV as he scrolls through his phone, his
brow furrowed in concern over a looming project deadline. Ricky, their scruffy terrier, weaves between them,
seeking attention and occasionally letting out a plaintive whine. As the evening wears on, Mary's pencils scratch
against paper, and Thomas's thumbs tap out a staccato rhythm on his phone's keyboard. The air is thick with the
scent of simmering tension, as unspoken worries and unmet expectations hang suspended between them. Yet, in
the comfortable silence, they find a fragile sense of comfort, a reassurance that, despite the unspoken, they are
still present for each other. As the clock ticks closer to bedtime, Mary sets aside her work, and Thomas finally
looks up, his eyes locking onto hers <span>in a fleeting moment of connection</span>. They exchange a soft,
wordless understanding, a promise to confront the unspoken another day. With a collective sigh, they rise, and the
evening's stillness is broken by the rustle of sheets and the soft thud of Ricky's tail as he settles into his bed beside
them.
Original Span: “in a fleeting moment of connection”
Edited Span: “for but a moment”

Using one or more of the span edit prompts 330, LLM 320 may generate an edited LLM-generated text 340. In some embodiments, a sequency of span edit prompts be used, where each prompt in the sequence results in editing for one type of category. In other words, edits may be made on a per category basis, as opposed to all at once. Alternatively, in some embodiments, multiple categories of edits may be generated by LLM 320 at once.

In some embodiments, edited LLM-generated text 340 may be stored in a text corpus with other edited LLM-generated responses, e.g., such as those generated by human participants as described herein.

FIG. 3B shows an application 350 of an LLM based AI agent, according to embodiments of the present disclosure. A user 352 may utter a query 356 in natural language. In response, a user device 354 may output/display an answer 340 on a display interface, such as a screen. In some embodiments, answer 340 is the output of an artificial intelligence (AI) agent, which is built on a bot server that is communicatively connected to user device 354. The AI agent may be based on, or include, an LLM. In some embodiments, the LLM receives query 356 through utterance of user 352, which may retrieve a corpus of documents, and generate an output based on the retrieved documents.

As an example, query 356 may include a question of “What information is needed for *client* orders?” The AI agent may include the query 356 in a predefined format providing instruction to the LLM how to generate a response to query 106, referred to as a “prompt,” which may be fed to an LLM as input. The LLM 360 may in turn generate an initial response to the query 356. The initial response may be edited using framework 300, described herein, and provide answer 340, e.g., a summary of the information needed for documentation of orders from a client or customer, e.g., a bullet-point format, such that each type of information needed is listed behind a bullet-point. In some aspects, for example, a citation of document(s) that include the information or are a form document for inputting information is provided behind the respective bullet. Answer 340 is the edited LLM-generated text as generated following framework 300, shown in FIG. 3A and described above.

The underlying LLM may be implemented at user device 354, or at a remote server which is accessible by the user device 354.

In some embodiments, proposed edits and/or identified spans of problematic text in the response generated by LLM 360 may be shown to user 352. User 352 may provide an indication accepting or rejecting one or more of the proposed edits and/or identified spans of problematic text. For example, the proposed edits and/or problematic spans may be the detected spans and categories 334 and edited LLM-generated text 340 as shown in FIG. 3A and described herein.

### Computer and Network Environment

FIG. 4A is a simplified diagram illustrating a computing device implementing the instruction-response pair generation and framework for editing LLM-generated text described in FIGS. 1-3, according to one embodiment described herein. As shown in FIG. 4A, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In another embodiment, processor 410 may comprise multiple microprocessors and/or memory 420 may comprise multiple registers and/or other memory elements such that processor 410 and/or memory 420 may be arranged in the form of a hardware-based neural network, as further described in FIG. 4B.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for LLM-Based Text Editing module 430 that may be used to implement and/or emulate the systems and models, and/or to implement any of the methods described further herein. LLM-Based Text Editing module 430 may receive input 440 such as an input training data or engineered prompts (e.g., sentences or paragraphs of sample text, which may or may not be edited, or instructions for generating text) via the data interface 415 and generate an output 450 which may be an LLM-edited version of LLM-generated text.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as an instruction requesting text generation, from a user via the user interface.

In some embodiments, the LLM-Based Text Editing module 430 is configured to automatically edit LLM-generated text as described herein. The LLM-Based Text Editing module 430 may further include Instruction-Response Generation submodule 431 (e.g., as described in FIG. 2A). Instruction-Response Generation submodule 431 may be configured to create instruction-response pairs, which may include an edited version of the response, as described herein. The LLM-Based Text Editing module 430 may further include Edit Prompt submodule 432 (e.g., as described in FIG. 2A-2B). Edit Prompt submodule 431 may be configured to generate or use engineered prompts to guide edits of an LLM-generated text as described herein. Additional LLM submodules 433A-433N may be available to perform the tasks of an LLM as described herein.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 4B is a simplified diagram illustrating the neural network structure implementing the LLM-Based Text Editing module 430 described in FIG. 4A, according to some embodiments. In some embodiments, the LLM-Based Text Editing module 430 and/or one or more of its submodules 431-433 may be implemented at least partially via an artificial neural network structure shown in FIG. 4B. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4A), such as a textual instruction, i.e., a request to generate text given certain instructions such as style, length, content, etc. The number of nodes (neurons) in the input layer 441 may be determined by the dimensionality of the input data (e.g., the length of a vector of indicative of the string size of one or more sentences or paragraphs comprising the instruction or text). Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4A, the LLM-Based Text Editing module 430 receives an input 440 of instruction for text generation and transforms the input into an output 450 of an LLM-edited LLM-generated text. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the LLM-Based Text Editing module 430 and/or one or more of its submodules 431-433 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be GPT-4, and/or the like.

In one embodiment, the LLM-Based Text Editing module 430 and its submodules 433A-433N may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the LLM-Based Text Editing module 430 and its submodules 431-433 may be implemented by hardware, software and/or a combination thereof. For example, the LLM-Based Text Editing module 430 and its submodules 431-433 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

For example, to deploy the LLM-based text editing module 430 and its submodules 431-433 and/or any other neural network models such as LLM 320 described in FIG. 3A onto hardware platform 460, the neural network based modules 430 and its submodules 431-433N may be optimized for deployment by converting it to a suitable format, such as ONNX or TensorRT, to improve performance and compatibility. Next, depending on the size and workload requirements for modules 430 and its submodules 431-433, hardware types may be chosen for deployment, e.g., processing capacity, GPU memory size, and/or the like. Frameworks and drivers for the chosen hardware 460 frameworks and drivers may thus be installed, such as PyTorch, TensorFlow, or CUDA, to support the hardware platform 460. Then, weights and parameters of the LLM-based text editing module 430 and its submodules 431-433 may be loaded to the hardware 460. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the LLM-based text editing module 430 and its submodules 431-433 may be deployed as a service, then they may be integrated with an API endpoint, using tools like Flask, FastAPI, or a cloud platform serverless services, and is accessible by a remote user via a network.

In another embodiment, some or all of layers 441, 442, 443 and/or neurons 442, 445, 446, and operations there between such as activations 461, 462, and/or the like, of the LLM-Based Text Editing module 430 and its submodules 431-433 may be realized via one or more ASICs. For example, each neuron 442, 445 and 446 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the LLM-Based Text Editing module 430 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based LLM-Based Text Editing module 430 and one or more of its submodules 431-433 may be trained by iteratively updating the underlying parameters (e.g., weights 451, 452, etc., bias parameters and/or coefficients in the activation functions 461, 462 associated with neurons) of the neural network based on a loss function/objective. For example, during forward propagation, the training data such as instructions are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding textual response to an instruction) from the training data, to compute a loss function that measures the discrepancy between the predicted output and the expected output. For example, the loss function may be any of a number of loss functions, e.g., cross entropy, MMSE, etc. Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

In one embodiment, the neural network based LLM-Based Text Editing module 430 and one or more of its submodules 431-433 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

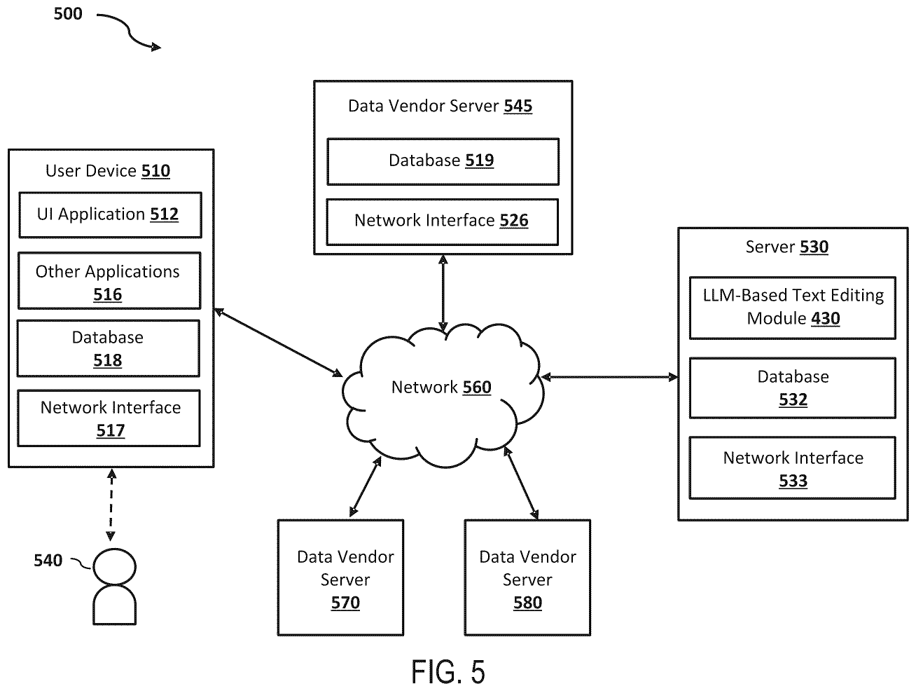

In one embodiment, LLM-Based Text Editing module 430 and its submodules 431-433 may be housed at a centralized server (e.g., computing device 400) or one or more distributed servers. For example, one or more of LLM-Based Text Editing module 430 and its submodules 431-433 may be housed at external server(s). The different modules may be communicatively coupled by building one or more connections through application programming interfaces (APIs) for each respective module. Additional network environment for the distributed servers hosting different modules and/or submodules may be discussed in FIG. 5.

During a backward pass, parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as editing LLM-generated text.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in AI-based writing assistants.

FIG. 5 is a simplified block diagram of a networked system 500 suitable for implementing the instruction-response pair generation and framework for editing LLM-generated text framework described in FIGS. 1-3 and other embodiments described herein. In one embodiment, system 500 includes the user device 510 which may be operated by user 540, data vendor servers 545, 570 and 580, server 530, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4A, operating an OS such as a MICROSOFT® OS, a UNIX® OS, a LINUX® OS, or other suitable device and/or server-based OS. It can be appreciated that the devices and/or servers illustrated in FIG. 5 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 510, data vendor servers 545, 570 and 580, and the server 530 may communicate with each other over a network 560. User device 510 may be utilized by a user 540 (e.g., a driver, a system admin, etc.) to access the various features available for user device 510, which may include processes and/or applications associated with the server 530 to receive an output data anomaly report.

User device 510, data vendor server 545, and the server 530 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560.

User device 510 may be implemented as a communication device that may utilize appropriate hardware and software configured for wired and/or wireless communication with data vendor server 545 and/or the server 530. For example, in one embodiment, user device 510 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLER. Although only one communication device is shown, a plurality of communication devices may function similarly.

User device 510 of FIG. 5 contains a user interface (UI) application 512, and/or other applications 516, which may correspond to executable processes, procedures, and/or applications with associated hardware. For example, the user device 510 may receive a message indicating an edited LLM-generated text from the server 530 and display the message via the UI application 512. In other embodiments, user device 510 may include additional or different modules having specialized hardware and/or software as required.

In one embodiment, UI application 512 may communicatively and interactively generate a UI for an AI agent or AI-based writing assistant implemented through the LLM-Based Text Editing module 430 (e.g., an LLM agent or LLM-based writing assistant) at server 530. In at least one embodiment, a user operating user device 510 may enter a user utterance, e.g., via text or audio input, such as a question, uploading a document, and/or the like via the UI application 512. Such user utterance may be sent to server 530, at which LLM-Based Text Editing module 430 may generate a response via the process described in FIGS. 1-3. The LLM-Based Text Editing module 430 may thus cause a display of edited LLM-generated text at UI application 512 and interactively update the display in real time with the user utterance.

In various embodiments, user device 510 includes other applications 516 as may be desired in particular embodiments to provide features to user device 510. For example, other applications 516 may include security applications for implementing client-side security features, programmatic client applications for interfacing with appropriate application programming interfaces (APIs) over network 560, or other types of applications. Other applications 516 may also include communication applications, such as email, texting, voice, social networking, and IM applications that allow a user to send and receive emails, calls, texts, and other notifications through network 560. For example, the other application 516 may be an email or instant messaging application that receives a prediction result message from the server 530. Other applications 516 may include device interfaces and other display modules that may receive input and/or output information. For example, other applications 516 may contain software programs for asset management, executable by a processor, including a graphical user interface (GUI) configured to provide an interface to the user 540 to view edited LLM-generated text.

User device 510 may further include database 518 stored in a transitory and/or non-transitory memory of user device 510, which may store various applications and data and be utilized during execution of various modules of user device 510. Database 518 may store user profile relating to the user 540, predictions previously viewed or saved by the user 540, historical data received from the server 530, and/or the like. In some embodiments, database 518 may be local to user device 510. However, in other embodiments, database 518 may be external to user device 510 and accessible by user device 510, including cloud storage systems and/or databases that are accessible over network 560.

User device 510 includes at least one network interface component 517 adapted to communicate with data vendor server 545 and/or the server 530. In various embodiments, network interface component 517 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 545 may correspond to a server that hosts database 519 to provide training datasets or engineered prompts including instruction-response pairs and/or edited versions of the response to the server 530. The database 519 may be implemented by one or more relational database, distributed databases, cloud databases, and/or the like.

The data vendor server 545 includes at least one network interface component 526 adapted to communicate with user device 510 and/or the server 530. In various embodiments, network interface component 526 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 545 may send asset information from the database 519, via the network interface 526, to the server 530.

The server 530 may be housed with the LLM-Based Text Editing module 430 and its submodules described in FIG. 4A. In some implementations, LLM-Based Text Editing module 430 may receive data from database 519 at the data vendor server 545 via the network 560 to generate edited LLM-generated text. The generated text may also be sent to the user device 510 for review by the user 540 via the network 560.

The database 532 may be stored in a transitory and/or non-transitory memory of the server 530. In one implementation, the database 532 may store data obtained from the data vendor server 545. In one implementation, the database 532 may store parameters of the LLM-Based Text Editing module 430. In one implementation, the database 532 may store previously generated engineered edit prompts or edited LLM-generated text, and the corresponding input feature vectors.

In some embodiments, database 532 may be local to the server 530. However, in other embodiments, database 532 may be external to the server 530 and accessible by the server 530, including cloud storage systems and/or databases that are accessible over network 560.

The server 530 includes at least one network interface component 533 adapted to communicate with user device 510 and/or data vendor servers 545, 570 or 580 over network 560. In various embodiments, network interface component 533 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 560 may be implemented as a single network or a combination of multiple networks. For example, in various embodiments, network 560 may include the Internet or one or more intranets, landline networks, wireless networks, and/or other appropriate types of networks. Thus, network 560 may correspond to small scale communication networks, such as a private or local area network, or a larger scale network, such as a wide area network or the Internet, accessible by the various components of system 500.

### Example Work Flows

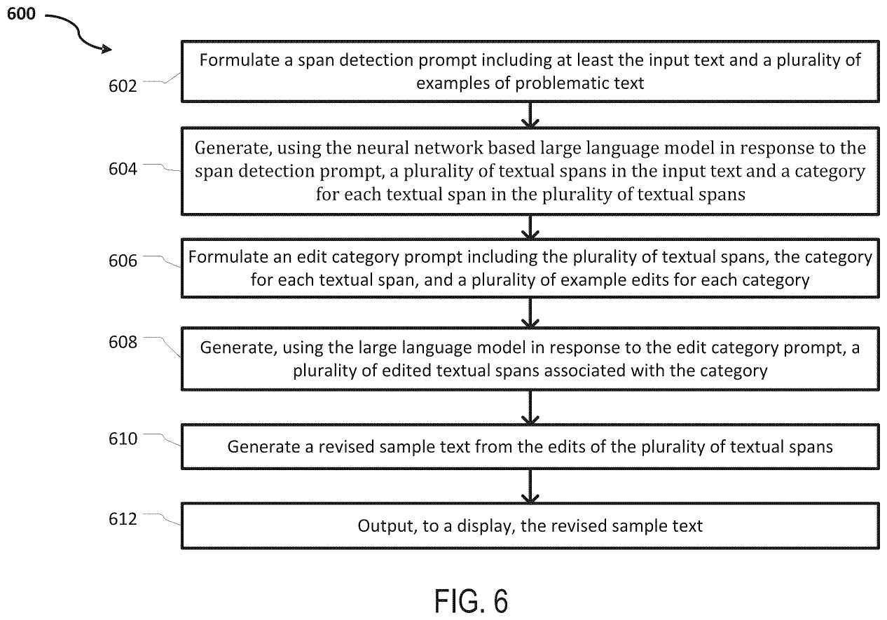

FIG. 6 is an example logic flow diagram illustrating a method of editing LLM-generated text based on the framework shown in FIGS. 1-4, according to some embodiments described herein. One or more of the processes of method 600 may be implemented, at least in part, in the form of executable code stored on non-transitory, tangible, machine-readable media that when run by one or more processors may cause the one or more processors to perform one or more of the processes. In some embodiments, method 600 corresponds to the operation of the LLM-based text editing module 430 (e.g., FIGS. 4A and 5) that performs editing of LLM-generated text.

In some embodiments, method 600 is performed by a system such as computing device 400, user device 510, server 530, or another device or combination of devices. Inputs (e.g., LLM generated text or a user query requesting a response from an LLM) may be received via a data interface such as data interface 415, network interface 517, network interface 533, or via a data interface that is integrated with a device. For example, UI Application 512 may receive user inputs via a text input interface (e.g., keyboard), audio input (e.g., microphone), video interface (e.g., camera), or other interface for receiving user inputs (e.g., a mouse or touch display).

As illustrated, the method 600 includes a number of enumerated steps, but aspects of the method 600 may include additional steps before, after, and in between the enumerated steps. In some aspects, one or more of the enumerated steps may be omitted or performed in a different order.

At step 602, a span detection prompt (e.g., span detection and categorization prompt 310 in FIG. 3A) is formulated which includes at least the input text (e.g., LLM-generated text 312) and a plurality of examples of problematic text (e.g., example spans and categories 314). In some embodiments, the input text may be generated by a language model 360 in response to a user query 356 provided to an AI agent as shown in FIG. 3B and described herein. In some embodiments, the AI agent may be deployed in as AI-based writing assistant or other user aid tool.

At step 604, a neural network based large language model (e.g., LLM 320 in FIG. 3A) generates a plurality of textual spans (e.g., detected spans and categories 334 in FIG. 3A) in the input text and a category (e.g., detected spans and categories 334 in FIG. 3A) for each textual span in the plurality of textual spans in response to the span detection prompt. In some embodiments the neural network based large language model may be instructed through a prompt to only identify non-overlapping problematic spans. In some embodiments, the categories may be one or more of cliché, unnecessary exposition, purple prose, poor sentence structure, lack of specificity, awkward word choice and phrasing, or tense inconsistency.

At step 606, an edit category prompt (e.g., span edit prompt 330 in FIG. 3A) is formulated and includes the plurality of textual spans, the category for each textual span, and a plurality of example edits for each category (e.g., example spans and edits 332 in FIG. 3A). In some embodiments, the plurality of example edits are selected based on a score, e.g., the initial writing quality score, final writing quality score, the difference between the final writing quality score and the initial writing quality score, or any other combination of scores or score.

At step 608, Generate, using the neural network based large language model (e.g., LLM 320 in FIG. 3A) in response to the edit category prompt, a plurality of edited textual spans associated with the category. In some embodiments, a neural network based large language model may generate edits of the textual spans for each category separately, i.e., in a sequence through each of the categories.

At step 610, a revised sample text (e.g., edited LLM-generated text 340 in FIG. 3A) is generated from the edits of the plurality of textual spans.

At step 612, the revised sample text is output to a display. In some embodiments, the revised sample text is displayed on a user device, such as user device 354, 510. In some embodiments, server 530 may receive an indication from a user to accept the edits of the plurality of textual spans. In some embodiments, a user provides an indication through user device 354, 510 either accepting or rejecting edits determined through framework 300, shown in FIG. 3A and described herein. In some embodiments, if the user accepts the edits, then the edited text (e.g., edited LLM-generated text 340 in FIG. 3A) may be stored in a text corpus. In some embodiments, text corpus may include human-edited LLM generated responses and LLM-edited LLM-generated responses. In some embodiments, text corpus may be stored locally on a user device and/or in databases 519, 532.

In some embodiments, method 600 is applicable in a variety of applications. For example, the task request received by a neural network model (e.g., LLMs 320, 360 in FIGS. 3A and 3B) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 600, the neural network based artificial agent may improve technology in the respective technical field in healthcare and diagnostics, education and personalized learning, software development and code assistance, content creation, autonomous system (such as autonomous driving, etc.), and/or the like.

### Example Results

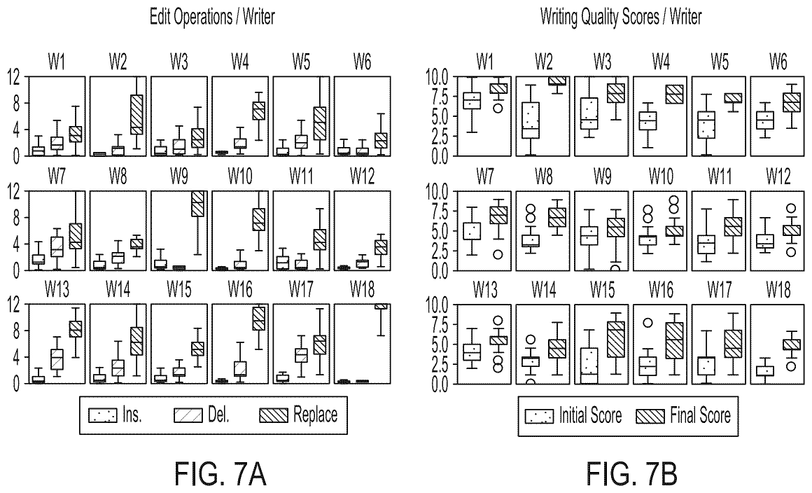

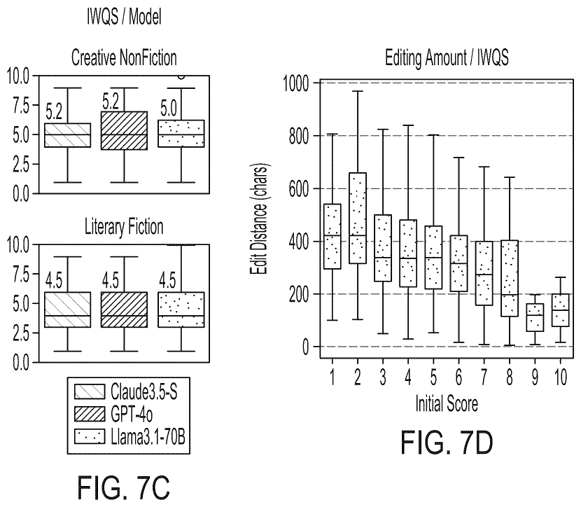

FIGS. 7-16 represent exemplary test results using embodiments described herein.

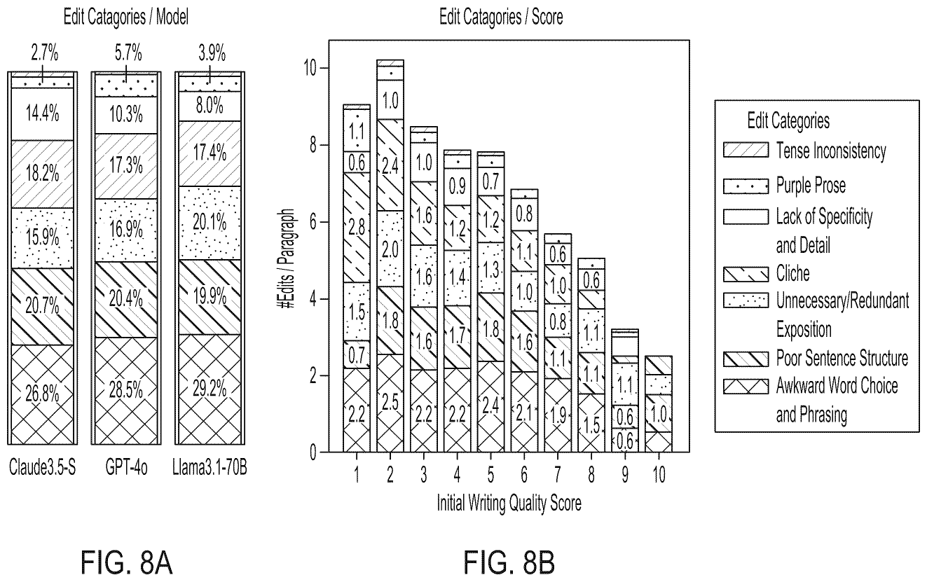

The LAMP Corpus was created by collaborating with 18 writers who edited 1,057 LLM-generated paragraphs, gathering about 8 edits per paragraph, totaling 8,035 fine-grained edits. The data includes paragraphs from Claude3.5 Sonnet (368), GPT40 (393), and Llama3.1-70B (296). In some embodiments, the LAMP Corpus is created as described herein in FIGS. 2-3. FIGS. 7-8 present analyses of the LAMP Corpus, offering insights into how professional writers edit LLM-generated text and revealing a surprising lack of difference in writing quality across different model families. The editing process is analyzed by examining edit operations: insertion, deletion, or replacement. An edit is an insertion if it deletes no characters and adds 40+ characters net. Conversely, it's a deletion if it adds no characters and removes 40+ characters net. All other edits are replacements. FIG. 7A shows edit operations by participant for each paragraph. Replacements are most frequent (74%), followed by deletions (18%) and insertions (8%). Editing styles vary: some participants primarily use replacements (W2, W9, W10, W16, W18), while others employ deletions more often (W1, W5, W7, W8, W13, W17). Insertions are uncommon across all participants. Semantic similarity is calculated to quantify meaning-preserving vs. meaning-changing edits between original and edited text using BERT score. Using a threshold of 0.6, edits with similarity >0.6 as meaning-preserving are classified. Of 6468 non-deletion edits, 70% are meaning-preserving, with the rest meaning-changing. This finding supports the Design Principle 2.

The annotation interface allowed participants to provide Initial and Final Writing Quality Scores (IWQS and FWQS) for each paragraph, ranging from 1 to 10. FIG. 7B shows the distribution of these scores for each participant, revealing significant variability (e.g., W1's median IWQS is 7, W18's is 2). Calibration of writing quality scores is a known challenge, and the present invention follows prior work in normalizing the scores into z-Scores by subtracting the mean, dividing by the standard deviation of the scores for each participant [40, 65], and re-scaling them to the 1 to 10 range. Subsequent analyses use these normalized scores.

An edit distance is computed between the original LLM-generated text and the final edited text, by calculating a character-level Levenshtein distance (as in Vladimir I. Levenshtein. 1966. Binary Codes Capable of Correcting Deletions, Insertions and Reversals. Soviet physics. Doklady 10 (1966), 707-710), between the two strings of texts. The edit distance measures the “amount of editing work” performed by a writer. FIG. 7D shows a negative correlation between edit distance and IWQS (Pearson's r=−0.31), indicating that higher perceived text quality (high IWQS) requires less editing, while lower IWQS necessitates more editing.

FIG. 7C shows the average IWQS for each LLM on creative non-fiction and fiction writing tasks. Writers were unaware of which model generated each text, and tasks were shuffled to avoid bias. This analysis estimates the writing quality of the three models in both domains. Comparing model scores, there is no significant difference in writing quality across the three models. GPT-40 and Claude 3.5-Sonnet perform slightly better on creative non-fiction instructions (average 5.2) compared to Llama3.1-70B (5.0), though the difference is not statistically significant. All models show a slight decrease in performance for fictional instructions, with an average IWQS of 4.5. This suggests fiction writing may be more challenging for may be more challenging for LLMs than creative non-fiction. These findings differ from task-oriented benchmarks that reveal performance gaps between models in areas like factual or logical reasoning. The results indicate that, when it comes to creative writing, writers perceived no significant qualitative differences among the texts generated by large language models (LLMs) such as GPT-4, Claude 3.5 Sonnet, and Llama 3.1 70B.

FIG. 8A displays edit categories applied by writers to texts from three LLMs. The distribution is similar across models, with the most common categories being Awkward Word Choice and Phrasing (28%), Poor Sentence Structure (20%), Unnecessary/Redundant Exposition (18%), and Clichés (17%). Minor differences include GPT-40 using more purple prose and Llama3.1-70B generating more unnecessary exposition. Overall, LLMs across the three model families exhibit similar idiosyncrasies that are edited out in similar proportions by professional writers. FIG. 8B illustrates the relationship between edit categories and IWQS. Higher IWQS scores correspond to fewer total edits, with texts rated 2 averaging 10.2 edits and those rated 10 receiving 2.4 edits, confirming that higher-quality texts need less editing. This trend however varies across edit categories: “Unnecessary/Redundant Exposition” and “Lack of Specificity and Detail” remain relatively constant, while the number of “Awkward Word Choice and Phrasing” and “Cliché” edits decrease as IWQS increases, suggesting a stronger correlation with perceived writing quality.

The writer's approaches to editing vary based on personal or organizational philosophy. Some prioritize preserving the original voice and make minimal changes to preserve authenticity. Others may take a more interventionist stance, heavily revising to align with their vision or house style. Additionally, some writers might make fewer but more impactful changes, while some might make numerous small revisions. To quantify this, 3 writers (W3, W12, and W16) were asked to edit a subset of the same 50 paragraphs from the LAMP Corpus. As expected, these three writers differed in the amount of editing they did. W3 did 9.4 edits on average while W12 and W16 did 6.0 and 6.3 edits on average. On average the span level precision between the 3 writers was 0.57 suggesting a moderately significant agreement.

Sometimes writers select the exact same problematic span but assign different categories. For a span both W3 and W16 selected “the numbers glaring back at me like an unsolvable riddle” but chose separate categories (Table 12 Row 2, below). Similarly, W3 and W16 both choose the exact same span, but different categorizations. It should however be noted that both categorizations can be correct interpretations. When one relies on overused phrases or clichés, they often state the obvious or provide information that readers can easily infer implicitly. This results in redundant or superfluous exposition that doesn't add value to the narrative. Other times writers may select the same category but with only partially overlap on the selected span (Table 12 Row 1 W3 vs W12, below). Looking at Table 12 Row 4 and 5; W3 vs W12, below, there is a partial overlap in the selected span “and an unsettling sense of mystery that gnawed at me more than the inexplicable weight itself”. However, the selected categories are Purple Prose and Cliché respectively. Here again, it should be noted that Purple Prose is a style of writing that can be original or cliché, depending on its usage, context, and frequency. Not all elaborate writing is overused, but when certain ornate phrases or styles become too common, they can cross the line into cliché territory. W16 however did not edit this span. Diversity in edits among writers such as selecting different spans or rewriting it in an individualistic style is a positive aspect that prevents homogenization while still improving LLM-generated text.

TABLE 12
Original spans selected by 3 writers from the same paragraph
‘—’ denotes the span was deleted while editing.

| | W3 | W12 | W16 |
|---|---|---|---|
| Original | .the numbers glaring | glaring back at me like an unsolvable | , the number glaring back at |
| | back at me like an | riddle | me like an unsolvable riddle |
| | unsolvable riddle | | |
| Category | Cliché | Cliche | Unnecessary/Redundant |
| | | | Exposition |
| Edited | . The numbers stared | barreling over one another as they | — |
| | back | raced to some unseemly height. | |
| Original | and an unsettling sense | Her words felt like a placeholder for an | — |
| | of mystery that gnawed | answer neither of us had yet. I walked | |
| | at me more than the | out with a slip for blood tests and an | |
| | inexplicable weight | unsettling sense of mystery that | |
| | itself | gnawed at me more than the | |
| | | inexplicable weight itself. | |
| Category | Purple Prose | Cliché | Unnecessary/Redundant |
| | | | Exposition |
| Edited | — | But when I saw her turn to go, | — |
| | | whispering in the halls with a | |
| | | colleague, I knew there was still | |
| | | something she had yet to tell me. | |

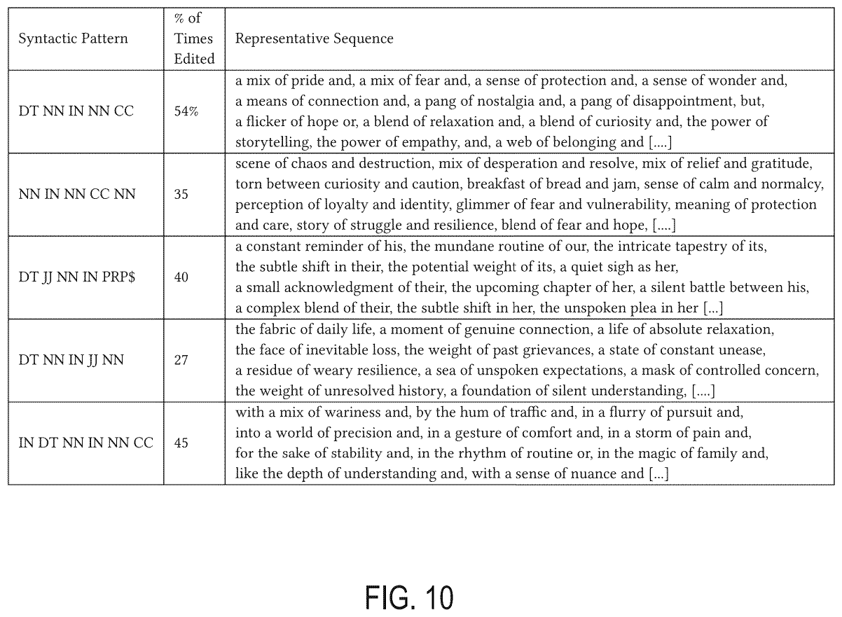

Syntactic patterns with Part-of-speech as abstract representations of texts can capture more subtle repetitions than mere text memorization. Language models tend to use repetitive syntactic templates more often than humans and these patterns can help evaluate style memorization in language models. Part of-speech templates of length ne {5, 6, 7, 8} in LLM generated responses were considered as well as the original seed human-written paragraphs. Looking at the 50 most common templates in LLM-generated responses, 15 templates do not occur as frequently in original human-written seed paragraphs. FIG. 10 shows representative sequences corresponding to particular syntactic patterns present in higher proportion in LLM-generated responses. These sequences constitute categories of Clichés, Unnecessary/Redundant Exposition or Poor Sentence Structure and are often heavily edited by writers in the study.

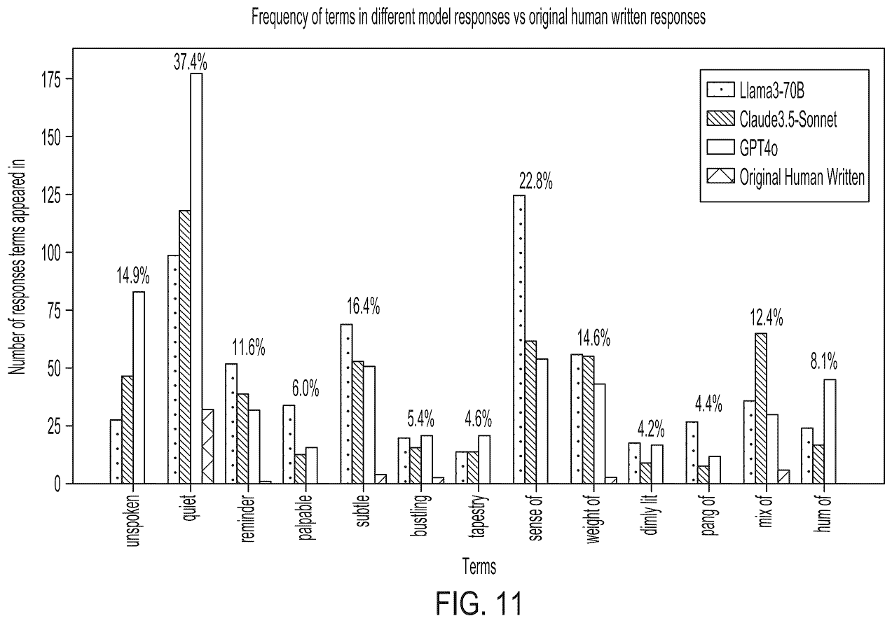

Awkward words/phrases occurring disproportionately in LLM generated responses were studied to better understand idiosyncrasies. For instance, FIG. 11 shows how a word like unspoken occurs in about 15% of LLM-generated responses. Similarly, phrases such as weight of, sense of, mix of occur very rarely or not at all in original seed paragraphs while they occur frequently in LLM-generated responses. Peculiar and uncommon phrases generated by LLMs were found across several responses such as air was thick, hung in the air, eyes darting, a sense of unease (grew/growing/settles) in the pit of (her/my) stomach. The most surprising finding is that all 3 LLMs generate these idiosyncratic words/phrases suggesting possible overlap/mixture in instruction tuning data across model families or one model trained on synthetic data generated from another model.

Expert text editing can analyze and reduce LLM idiosyncrasies at a small scale, but automated methods are needed for resolution at a larger scale. Given automated evaluation limitations for text editing, a large-scale preference annotation study was conducted with LAMP Corpus writers, comparing human and LLM-produced edits. To accommodate methods that require training samples, data was split: 146 of 1057 LAMP Corpus paragraphs for training, the rest for testing.

The problem of detecting problematic spans in LLM-generated text is formulated as a multi-span categorical extraction problem. In other words, given a paragraph of LLM-generated text, the method must output a list of non-overlapping spans present in the original text, and assign a category to each extracted span (from the list of categories of the LAMP Corpus). To evaluate various methods, span-level precision metric is used, which is a common metric used in NLP tasks requiring comparison of extracted spans. Span-level precision measures the degree of overlap between predicted spans and reference or ground truth spans. The overlap is measured at the character level, such that spans that partially overlap will get precision scores that reflect the amount of overlap between the two spans. High span-level precision indicates that the model is precise in identifying the correct boundaries of relevant text spans without over-predicting. Two precision metric variants were implemented: General and Categorical Precision. General Precision credits span selection regardless of category assignment, while Categorical Precision requires correct category assignment. A precision-based metric was used (like BLEU, Papineni et al., 2002 Bleu: a method for automatic evaluation of machine translation. In Proceedings of the 40th annual meeting of the Association for Computational Linguistics. 311-318.) rather than recall-based (like ROUGE Chin-Yew Lin. 2004. Rouge: A package for automatic evaluation of summaries. In Text summarization branches out. 74-81.) as LLM-based methods tend to over-generate spans, which recall doesn't penalize. The focus is measuring overlap between generated and ground truth spans.

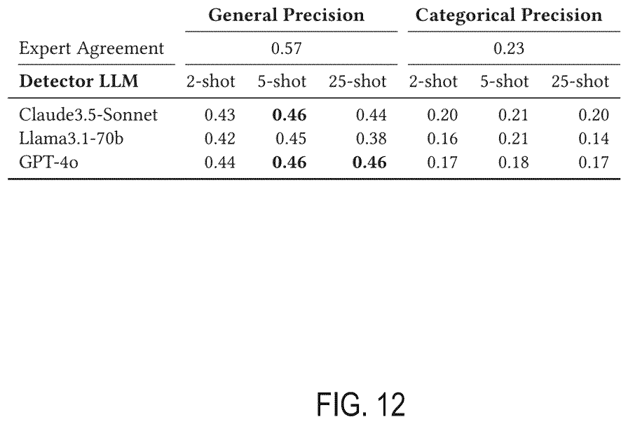

Few-shot LLM-based methods have demonstrated competitive performance on tasks across several disciplines, often using fewer than 100 examples. The experiment varies few-shot examples (2, 5, and 25) with the 2-shot prompt in Table 3, above, and tests Llama3.1-70B, GPT-40, and Claude3.5-Sonnet. As part of the collection of the LAMP Corpus, 50 paragraphs were edited independently, and General and Categorical Precision were computed on this set to estimate expert-expert agreement. FIG. 12 summarizes results. The best General Precision (0.46) is achieved by Claude-3.5 Sonnet and GPT-40 with a 5-shot prompt, below the expert agreement level (0.57). LLM-based methods can identify problematic spans with significant expert overlap, but improvement is possible. Performance improves from 2-shot to 5-shot prompts but plateaus thereafter (Claude-3.5 Sonnet and GPT-40 achieve similar or better performance with 5-shot vs. 25-shot prompts).

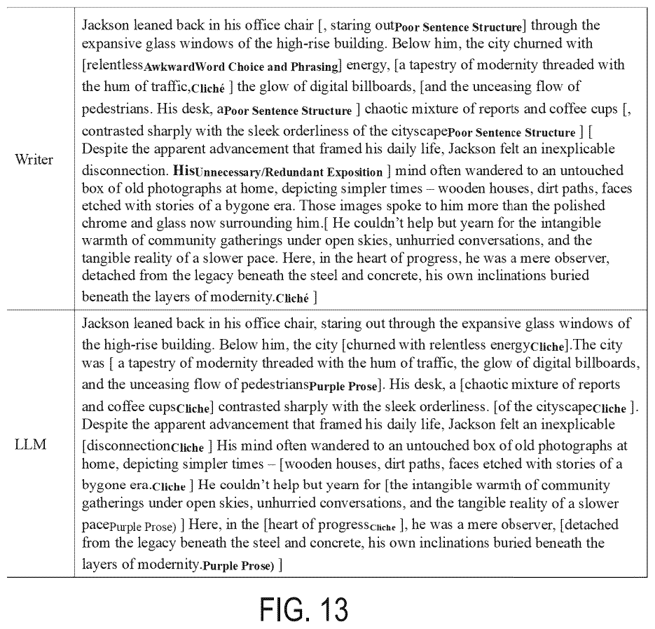

Categorical Precision is consistently lower than General Precision for both LLM-based methods and writer-writer comparison, suggesting that even when problematic spans are commonly identified, category agreement may differ. FIG. 13 illustrates the contrast between automatic editing and writer-selected edits by showing a paragraph with problematic spans and categories identified by a writer versus an LLM.

To propose improvements for detected problematic spans, few-shot prompting with LLMs are used. Prompts are designed for each of the seven edit categories, incorporating examples of rewrites from writers. Each prompt includes a category definition, 25 examples from the LAMP Corpus with original paragraphs, a single problematic span for the category, the expert-proposed rewrite, and finally the input paragraph with the target span to be rewritten. The prompts for each category are listed in Tables 5-11.

The detection and rewriting methods can form a two-step pipeline for editing paragraphs. Detection identifies problematic spans and assigns categories while rewriting uses category-specific prompts to revise each detected span. A final step replaces all problematic spans in the original paragraph with their rewrites. Unlike the detection task, the rewriting stage is not evaluated in isolation. Instead, the complete pipeline that edits an entire paragraph is judged (by detecting and rewriting multiple spans) through manual evaluation with 12 writers that annotated the LAMP Corpus. This manual experiment is described below.

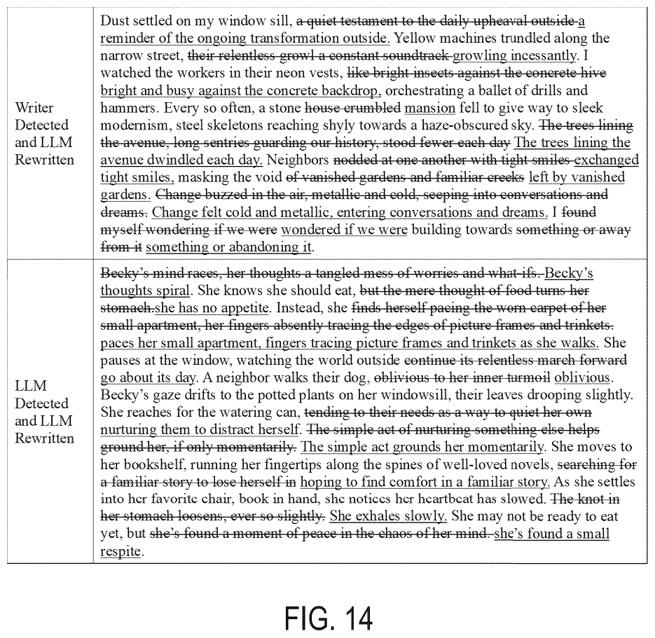

An evaluation task to evaluate editing quality involves participants reading three variants of a paragraph and ranking them in terms of overall preference: (1) an unedited LLM-generated paragraph from the LAMP Corpus, (2) the Writer-edited version from the LAMP Corpus, and (3) an LLM-edited version using the pipeline to detect and rewrite problematic spans. 12 of the 18 experts who had participated in creating the LAMP Corpus were re-hied for this evaluation. The LLM-edited variant was split into two further sub-conditions: (1) Writer Detected and LLM Rewritten: In this condition, the pipeline skips automatic detection of problematic spans, relying only on reference spans selected by the writer during manual editing. It runs solely the rewriting stage, simulating an oracle setting where problematic spans are manually provided. This condition is coded as LLM-edited-Oracle. (2) LLM Detected and LLM Rewritten: In this condition, the two-step pipeline is entirely automatic, with the automatically detected spans being provided to the automatic rewriting module. This condition fully automates editing of the paragraph and is coded as LLM-edited-full. FIG. 14 shows examples of LLM-edited paragraphs under both sub-conditions. In the pilot evaluation, all four conditions for annotation were included. However, ranking four paragraphs proved challenging for participants, especially when distinguishing between their second and third preferences. Based on this feedback, the task was redesigned to have participants judge only three conditions in each annotation. The LLM-generated and Writer-edited paragraphs were always included and alternated between including LLM-edited-oracle and LLM-edited-full paragraphs. To obtain automatic edits of a paragraph, the same LLM that had originally been used to generate the paragraph was used. While not optimal, as a single LLM might offer slightly better detection and rewriting capabilities, this approach allows us to simplify the experiment conceptually and also test the hypothesis if edits lead to overall better alignment without relying on a single model family. This is to assess whether using an LLM in a multi-stage pipeline (drafting, problem detection, rewriting) can enhance overall writing quality. To ensure fairness, paragraph variants are displayed in a shuffled order and anonymized, and participants were not informed about the difference between the paragraphs (i.e. whether they are edited). The experiments were conducted with a total of 200 paragraph triplets (100 including an LLM-edited-oracle paragraph, and 100 including an LLM-edited-full paragraph) selecting samples from the LAMP Corpus's test set. Preference judgments were collected in batches of 25-35 paragraph triplets. To account for potential subjectivity and to calculate agreement and reliability, three experts judged each triplet, totaling 600 annotated preference rankings. To ensure the validity of the results, no participant reviewed paragraphs they had seen or edited in past tasks, and only judged paragraphs edited by other experts.

To analyze the reliability of the results, inter-annotator agreement was calculated using Kendall's W (also known as Kendall's coefficient of concordance, as in Andy P Field. 2005. Kendall's coefficient of concordance. Encyclopedia of statistics in behavioral science 2 (2005), 1010-11.) which ranges from 0 (no agreement) to 1 (complete agreement) to evaluate agreement amongst participants. The annotation achieves an overall agreement of 0.505, suggesting a moderate level of agreement across all participants. This moderate agreement underscores the subjective nature of judging writing quality while suggesting that certain differences are distinctive enough to be consistently preferred by multiple participants.

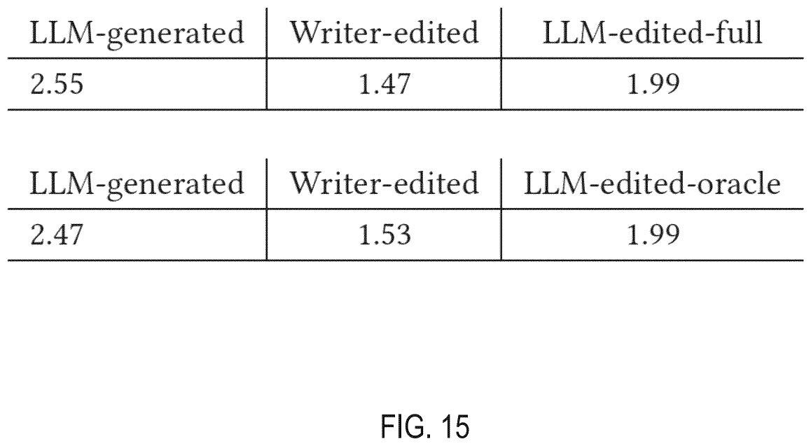

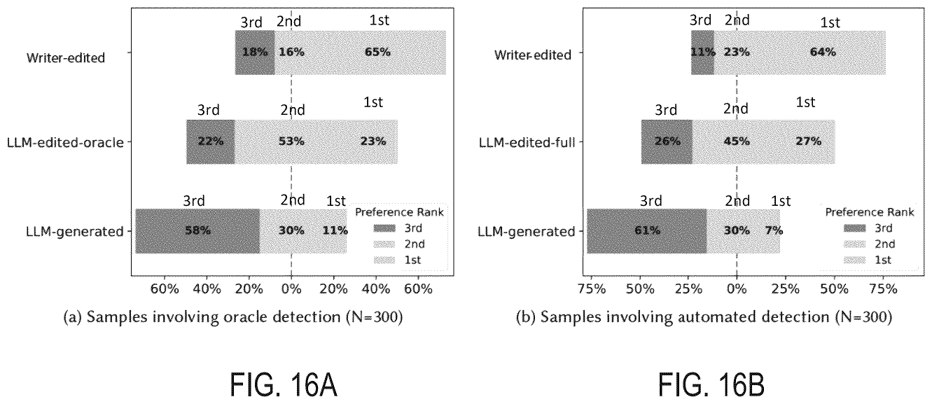

FIGS. 15-16 summarize the preference evaluation results, showing average ranks across 600 annotations. Overall, the Writer-edited condition is most preferred, a sign that expert-edited text is unrivaled in terms of writing quality, being marked as the most-preferred paragraph variant 65% of the time and achieving an average rank of 1.5. Next, the LLM-edited variants come in second, with an average rank of 1.99 for both the LLM-edited-oracle and LLM-edited-full conditions. Surprisingly, the condition that leveraged the oracle span from writers ranks almost identical to the condition with automatically detected spans. This provides evidence that detection of problematic spans is not the bottleneck in improving writing quality, and instead the rewriting module (which is common to both conditions) is what dictates the overall performance of an automated text-editing pipeline. Finally, the original LLM-generated paragraphs achieve the worst ranking performance, being least preferred 60% of the time, and achieving an average rank of 2.51. In summary, the experiment validates the potential benefit of automatic editing to improve writing quality: although automatic editing does match the quality of edits provided by professional writers, LLM-edited text is significantly preferred to LLM-generated text by expert writers (Design Principle 3). In other words, this experiment shows that LLMs can improve the quality of their writing in a fully automatic way, by first generating a draft, selecting problematic spans, and then rewriting such spans.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of detecting whether an input text is AI-generated using a neural network based language model, the method comprising:
formulating a span detection prompt including at least the input text and a plurality of examples of problematic texts;
generating, using the neural network based language model in response to the span detection prompt, a plurality of textual spans in the input text and a category for each textual span in the plurality of textual spans, wherein the category is selected from one or more of:
cliche;
unnecessary exposition;
purple prose;
poor sentence structure;
lack of specificity;
awkward word choice and phrasing; or
tense inconsistency;
formulating an edit category prompt including the plurality of textual spans, the category for each textual span, and a plurality of example edits for each category;
generating, using the neural network based language model in response to the edit category prompt, a plurality of edited textual spans associated with the category;
generating a revised sample text from the edits of the plurality of textual spans; and
outputting, to a display, the revised sample text.

2. The method of claim 1, further comprising:
receiving an indication from a user to accept the edits of the plurality of textual spans; and
storing the revised sample text in a text corpus that includes the plurality of example edits.

3. The method of claim 1, wherein the plurality of textual spans are non-overlapping in the input text.

4. The method of claim 1, wherein the input text is edited sequentially on a per category basis.

5. The method of claim 1, further comprising:
receiving a user query through at an AI-based agent including neural network-based language model; and
generating, using the neural network-based language model, the input text from the user query.

6. The method of claim 1, wherein each edit of the plurality of example edits includes a quality score indicative of writing quality.

7. The method of claim 6, further comprising:
selecting the plurality of example edits based on the quality score associated with each example edit in the plurality of example edits.

8. A system for detecting whether an input text is AI-generated using a neural network based language model, the system comprising:
a memory that stores a neural network based language model and a plurality of processor-executable instructions;
a communication interface that receives the input text; and
one or more hardware processors that read and execute the plurality of processor-executable instructions from the memory to perform operations comprising:
formulate a span detection prompt including at least the input text and a plurality of examples of problematic texts;
generate, using the neural network based language model in response to the span detection prompt, a plurality of textual spans in the input text and a category for each textual span in the plurality of textual spans, wherein the category is selected from one or more of:
cliche;
unnecessary exposition;
purple prose;
poor sentence structure;
lack of specificity;
awkward word choice and phrasing; or
tense inconsistency;
formulate an edit category prompt including the plurality of textual spans, the category for each textual span, and a plurality of example edits for each category;
generate, using the neural network based language model in response to the edit category prompt, a plurality of edited textual spans associated with the category;
generate a revised sample text from the edits of the plurality of textual spans; and
output, to a display, the revised sample text.

9. The system of claim 8, the operations further comprising:
receive an indication from a user to accept the edits of the plurality of textual spans; and
store the revised sample text in a text corpus that includes the plurality of example edits.

10. The system of claim 8, wherein the plurality of textual spans are non-overlapping in the input text.

11. The system of claim 8, wherein the input text is edited sequentially on a per category basis.

12. The system of claim 8, the operations further comprising:
receive a user query through at an AI-based agent including neural network-based language model; and
generate, using the neural network-based language model, the input text from the user query.

13. The system of claim 8, wherein each edit of the plurality of example edits includes a quality score indicative of writing quality.

14. The system of claim 13, the operations further comprising:
select the plurality of example edits based on the quality score associated with each example edit in the plurality of example edits.

15. A non-transitory machine-readable medium comprising a plurality of machine-executable instructions which, when executed by one or more processors, are adapted to cause the one or more processors to perform operations comprising:
formulate a span detection prompt including at least an input text and a plurality of examples of problematic texts;
generate, using the neural network based language model in response to the span detection prompt, a plurality of textual spans in the input text and a category for each textual span in the plurality of textual spans, wherein the category is selected from one or more of:
cliche;
unnecessary exposition;
purple prose;
poor sentence structure;
lack of specificity;
awkward word choice and phrasing; or
tense inconsistency;
formulate an edit category prompt including the plurality of textual spans, the category for each textual span, and a plurality of example edits for each category;
generate, using the neural network based language model in response to the edit category prompt, a plurality of edited textual spans associated with the category;
generate a revised sample text from the edits of the plurality of textual spans; and
output, to a display, the revised sample text.

16. The non-transitory machine-readable medium of claim 15, the operations further comprising:
receive an indication from a user to accept the edits of the plurality of textual spans; and
store the revised sample text in a text corpus that includes the plurality of example edits.

17. The non-transitory machine-readable medium of claim 15, wherein the plurality of textual spans are non-overlapping in the input text.

18. The non-transitory machine-readable medium of claim 15, wherein the input text is edited sequentially on a per category basis.

19. The non-transitory machine-readable medium of claim 15, the operations further comprising:
receive a user query through at an AI-based agent including neural network-based language model; and
generate, using the neural network-based language model, the input text from the user query.

20. The non-transitory machine-readable medium of claim 15, wherein each edit of the plurality of example edits includes a quality score indicative of writing quality.
